(19) United States
(12) Patent Application Publication
(10) Pub. No.: US 2019/0053667 A1
(43) Pub. Date: Feb. 21, 2019

(54) MOBILE GRILLING UNIT

(71) Applicant: Thurston Manufacturing Company, Thurston, NE (US)

(72) Inventor: Layton W. Jensen, Thurston, NE (US)

(73) Assignee: Thurston Manufacturing Company

(21) Appl. No.: 15/926,567

(22) Filed: Mar. 20, 2018

Related U.S. Application Data
(60) Provisional application No. 62/545,763, filed on Aug. 15, 2017.

(51) Int. Cl. A47J 37/07

(52) U.S. Cl. CPC A47J 37/0763; A47J 2037/0795; A47J 2037/0777; A47J 37/0786

(57) ABSTRACT

A mobile grilling unit including a base and roof secured together by a linkage assembly that enables the roof to be raised or lowered relative to the base. The base defines at least one storage compartment and includes dedicated apertures for receiving a barbeque grill, fuel tanks, coolers and other accessories. Legs detachably engage with the base. In a first position, a connector assembly secures the unit to a truck bed and enables the unit to move between tailgating and transportation positions. In a second position, the unit is free-standing and usable remote from the truck bed. The unit is stored in a third position after being rotated through ninety degrees to where the roof and base are in a vertical orientation such that a footprint of the unit on the ground is reduced in size. A power pack or vehicle trailer connector powers the linkage assembly and other accessories.

### CROSS-REFERENCE TO RELATED APPLICATIONS

This application claims the benefit of U.S. Provisional Patent Application Ser. No. 62/545,763, filed Aug. 15, 2017, the entire disclosure of which is incorporated herein by reference.

### BACKGROUND

### Technical Field

The present disclosure relates generally to the field of barbecue equipment. More particularly, the present disclosure relates to a mobile grilling unit. Specifically, the present disclosure relates to a mobile grilling unit that usable in multiple positions. In a first position, the grilling unit is mountable in a truck bed for transportation to other locations and for use for tailgating; in a second position, the grilling unit is detached from the truck and is usable as a free-standing unit; and in a third position, the grilling unit may be folded into a storage position that has a reduced footprint and is wheelable along the ground to a storage location.

### Background Information

Many people enjoy tailgating before sporting events. Some people enjoy taking a simple portable grill and placing it on the ground to cook hot dogs and hamburgers before the game. Others have more elaborate mobile grilling units that may be transported in a vehicle and may be placed on a truck tailgate at the sporting event.

U.S. Pat. No. 6,575,155 (Brennan), for example, discloses a portable grill and cooler apparatus that includes a raisable and lowerable platform which houses a removable charcoal or gas grill and a removable cooler chest. The apparatus also includes a storage compartment located between the grill and cooler chest and has sections that fold out to provide additional preparation surfaces. A wheeled scissors lift system is used to raise and lower the platform by manipulating a crank handle. The lift system includes components to engage a conventional hitch provided on a vehicle. The apparatus is collapsed and towed behind the vehicle. When a sporting venue is reached, the apparatus may be detached from the vehicle, wheeled to a desired location and then raised for use. The patent therefore discloses a free-standing grilling apparatus that is collapsed for towing behind a vehicle.

The Tailgate Kitchen® by Champion Tailgate of Wauconda Ill., United States includes a specially configured box and a separate wheelable cart that allows the box to be transported to and from a vehicle. The box houses a collapsed telescoping frame, planar table sections, a portable grill, coolers, and various baskets. The box is placed in a rear end of a truck or sport utility vehicle (SUV) for transportation. (The cart is left at home.). When the sporting venue is reached, the user will partially withdraw an end of the frame from the box and will attach a first pair of legs thereto. Grasping the end of the frame, the user will walk away from the rear end of the vehicle. This will result in the telescoping frame extending to its use position. The first pair of legs is placed in contact with the ground and additional legs are engaged with the frame at various locations between the vehicle and the first pair of legs. One end of the frame remains secured to the box that remains in the vehicle. The underside of the portable grill interlocks with the frame. Once all the legs are in place, the user will slide the grill along the frame to a predetermined position and lock the grill in place. The table sections are unpacked from the box and are engaged in the frame to provide a work surface adjacent the grill. Coolers and the various baskets are unpacked from the box and are engaged with the frame. The apparatus is then ready for use. The aforementioned steps are reversed when it is time to leave. When back at home, the cart is wheeled to the back of the vehicle. Rails are extended outwardly from the cart and the ends of the rails are placed on the vehicle bed. Wheels on the bottom of the box are aligned with the rails and the box is then rolled from the vehicle and back onto to the cart along the rails. The cart with the box sitting on top of the same is then rolled away from the vehicle to a storage location. This apparatus is therefore only usable in a tailgate setting.

Toyota® has specially fabricated a limited number of trucks that have tailgating grills permanently mounted therein. A drawer-like apparatus slides out of the truck bed. A grill, coolers, beer taps and various storage boxes are provided in the drawer-like apparatus. A roof is mounted on the truck frame and is positioned directly over the truck bed. The roof is able to be vertically raised and lowered relative to the truck bed. The drawer slides under this roof when not in use. The system may include various accessories such as an audio system, TV system and gaming system, most of which are provided on the roof. These tailgating trucks are not available to the general public but are intended for use as promotional vehicles at various events and festivals.

### SUMMARY

While there are a wide variety of mobile grilling units available in the art ranging from simple charcoal grills to elaborate devices permanently mounted on trucks, there is still a need in the art for a mobile grilling that is suitable for use as a tailgate party device. The mobile grilling unit disclosed herein is one such system.

A mobile grilling unit is disclosed herein that includes a base and roof which are secured together by a linkage assembly. The linkage assembly enables the roof to be raised or lowered relative to the base. The base defines at least one storage compartment and includes dedicated apertures for receiving a barbeque grill, fuel tanks, coolers and other accessories. Legs are detachably engaged with the base. In a first position, a connector assembly secures the unit to a truck bed and enables the unit to move between tailgating and transportation positions. In a second position, the unit is free-standing and usable remote from the truck bed. The unit is stored in a third position after having been rotated through ninety degrees to where the roof and base are in a vertical orientation such that a footprint of the unit on the ground is reduced in size. A power pack powers the linkage assembly and other accessories.

In one aspect, the present disclosure may provide a mobile grilling unit comprising a base; a barbeque grill engaged with the base; a roof oriented substantially parallel to the base; and at least one linkage assembly engaging the roof to the base; said at least one linkage assembly being actuatable to move the roof between a raised position and a lowered position relative to the base. The at least one linkage assembly includes a threaded rod and cylinder or a pneumatic cylinder as an actuator. The unit further comprises at least one first leg and at least one second leg that are selectively detachably engageable with the base, said at least one first leg being spaced longitudinally from said at least one second leg. The unit further comprises at least one first wheel and at least one second wheel engaged with the base; wherein said at least one first wheel is spaced longitudinally from said at least one second wheel.

The base has a front end, a back end and a top wall extending between the front end and back end; wherein when the roof is in the lowered position, the top wall of the base is covered by the roof; and wherein when the roof is in the raised position, a region of the top wall of the base is not covered by the roof and a section of the roof is located forwardly of the front end of the base. In other instances, the base includes a front end, a back end, and a top wall extending between the front end and the back end; and wherein at least one aperture is defined in the top wall; and each of the at least one aperture is adapted to receive an accessory device therein. A first one of the at least one aperture receives the barbeque grill therein. A second one of the at least one aperture receives one of a fuel tank, a cooler, or a power pack therein. The base defines a storage compartment therein.

A connector assembly is engaged with the base; and the connector assembly is adapted to selectively secure the base to a wall of a truck bed. The connector assembly comprises one or more guide bars operatively engaged with the base and a mounting plate adapted to be engaged with the wall of the truck bed; and wherein the one or more guide bars are selectively engageable with the mounting plate. The base defines one or more pockets therein and each of the one or more guide bars is slidably received in one of the one or ore pockets.

A wheel assembly is selectively engageable with a front end of the roof and a front end of the base when the roof is in the lowered position; wherein the mobile grilling unit is selectively movable through ninety degrees from a use position to a storage position; and when in the storage position, the roof and base are supported on the wheel assembly. A power pack is selectively engageable with the linkage assembly.

In another aspect, the disclosure may provide a method of utilizing a mobile grilling unit comprising steps of providing a mobile grilling unit including a base, a barbeque grill engaged with the base; a roof oriented substantially parallel to the base and a linkage assembly engaged the roof to the base; actuating the linkage assembly; and moving the roof between a raised position and a lowered position relative to the base. The step of actuating the linkage assembly results in the roof being moved to the raised position; and wherein the method further comprises a step of grilling food on the barbeque grill. The step of actuating the linkage assembly results in the roof being moved to the raised position, and the method further comprises steps of extending a region of the roof beyond a front end of the base; and sheltering a person grilling food on the barbeque grill. The method may further comprise steps of moving the mobile grilling unit between a use position and a storage position; and reducing a footprint of the mobile grilling unit on a ground surface when the mobile grilling unit is moved from the use position to the storage position by rotating the mobile grilling unit through ninety degrees between the use position and the storage position. The step of moving the mobile grilling unit between the use position and the storage position includes steps of engaging roll plates on front legs on the base; engaging a wheel assembly with a front end of the base and a front end of the roof; contacting a ground surface with an arcuate surface of each roll plate; rotating the mobile grilling unit onto the wheel assembly; and supporting the mobile grilling unit on the wheel assembly.

The method may further comprise a step of moving the mobile grilling unit between a free-standing position and a tailgating position. The step of moving the mobile grilling unit into a tailgating position comprises steps of positioning the mobile grilling unit on a bed of a truck; securing the mobile grilling unit to the truck bed; and moving the mobile grilling unit into a first region of the truck bed for transportation and into a second region of the truck bed for barbequing. The step of securing further comprises steps of engaging a mounting plate to a wall on the truck bed; sliding a pair of guide bars out of the base; engaging ends of the pair of guide bars with the mounting plate; and locking the pair of guide bars in place. The step of moving the mobile grilling unit includes moving the mobile grilling unit into a transportation position including steps of moving the base to a position where the base clears a tailgate on the truck; closing the tailgate; actuating the linkage assembly to lower the roof toward the base; and contacting an upper end of the tailgate and walls defining the truck bed with the roof.

In another aspect, the disclosure may provide a mobile grilling unit comprising a base adapted to retain a barbeque grill therein; a roof; a linkage assembly connecting the base and roof together and being operable to adjust a position of the roof relative to the base; a pair of first legs and a pair of second legs selectively detachably engageable with the base; wherein the mobile grilling unit is selectively adjustable between a first position, a second position, and a third position; and when in the first position, the mobile grilling unit is engaged with a truck bed; when in the second position the mobile grilling unit is free-standing and located remote from the truck bed; and when in the third position the mobile grilling unit is rotated through ninety degrees and has a reduced footprint on a ground surface upon which the mobile grilling unit stands and is storable remote from the truck bed.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a right side elevation view of a mobile grilling unit in accordance with the present invention shown in a standing position;

FIG. 2 is a front elevation view of the mobile grilling unit shown in FIG. 1;

FIG. 3 is a top plan view of the mobile grilling unit taken along line 3-3 of FIG. 1;

FIG. 4 is a top plan view of the mobile grilling unit taken along line 4-4 of FIG. 1;

FIG. 5 is an exploded right side elevation view of the mobile grilling unit of FIG. 1;

FIG. 6 is a longitudinal cross-section of the roof of mobile grilling unit taken along line 6-6 of FIG. 3, with the satellite receiver, the satellite receiver mount and shroud removed for clarity;

FIG. 7 is a lateral cross-section of the roof of the mobile grilling unit with the satellite receiver, the satellite receiver mount and shroud removed for clarity;

FIG. 8 is a right side elevation view of the mobile grilling unit showing a first step in moving the roof from the erected position shown in FIG. 1 to a collapsed position; the shroud has been removed for clarity in this figure and all subsequent figures;

FIG. 9 is a right side elevation view of the mobile grilling unit showing a second step in moving the roof from the erected position to a collapsed position;

FIG. 10 is a right side elevation view of the mobile grilling unit showing a third step in moving the roof from the erected position to a collapsed position;

FIG. 11 is a right side elevation view of the mobile grilling unit showing a first step in moving the grilling unit from a standing position to a folded position;

FIG. 12 is a right side elevation view of the mobile grilling unit showing a second step in moving the grilling unit from the standing position to a folded position;

FIG. 13 is a right side elevation view of the mobile grilling unit showing a third step in moving the grilling unit from the standing position to a folded position;

FIG. 14 is a right side elevation view of the mobile grilling unit showing a fourth step in moving the grilling unit from the standing position to a folded position;

FIG. 15 is a right side elevation view of the mobile grilling unit showing a fifth step in moving the grilling unit from the standing position to a folded position;

FIG. 16 is a right side elevation view of the mobile grilling unit showing a sixth step in moving the grilling unit from the standing position to a folded position;

FIG. 17 is a right side elevation view of the mobile grilling unit showing the grilling unit in the folded position and showing the legs being disengaged from the grilling unit;

FIG. 18 is a right side elevation view showing the mobile grilling unit in the folded position with the legs removed and wherein the grilling unit is in an orientation ready for storage;

FIG. 19 is a right side elevation view with the roof in the collapsed position and the grilling unit in an angled leg, braked standing position;

FIG. 20 is a right side elevation view with the roof in the erected position, the grilling unit in a vertical leg, free-rolling and standing position but being readied to fold the legs for engagement of the grilling unit with a connector assembly provided on a truck bed;

FIG. 21 is a right side elevation view of the grilling unit with the roof in a nearly-erected position, the pair of first legs removed from the grilling unit and with the grilling unit positioned with the connector extended and ready to be engaged with the connector assembly provided in the truck bed;

FIG. 22 is a right side elevation view with the grilling unit moved inwardly until at least a portion thereof is seated in the truck bed and the connector being pinned to the supplied bulkhead;

FIG. 23 is a right side elevation view of the grilling unit entirely seated on the truck bed and with the pair of second legs detached from the grilling unit;

FIG. 24 is a top plan view of the mobile grilling unit seated on the truck bed and with the truck bed's tailgate moved to a closed position.

FIG. 25 is a front view of a panel of the connection assembly secured in position to the bulkhead of the truck;

FIG. 26 is a cross-section taken along line 26-26 of FIG. 25;

FIG. 27 is a right side elevation view of the mobile grilling moved within the truck bed until a portion thereof is seated on the truck's tailgate and with the roof moved to an erected position;

FIG. 28 is a right side elevation view of the mobile grilling moved toward the rear wall of the cab of the truck and with the roof moved partially rearwardly to cover only the front end of the mobile grilling unit; and

FIG. 29 is a right side elevation view of the mobile grilling unit moved to a position where the roof entirely covers the mobile grilling unit and is in the closed position and the tailgate of the truck is closed.

Similar numbers refer to similar parts throughout the drawings.

### DETAILED DESCRIPTION

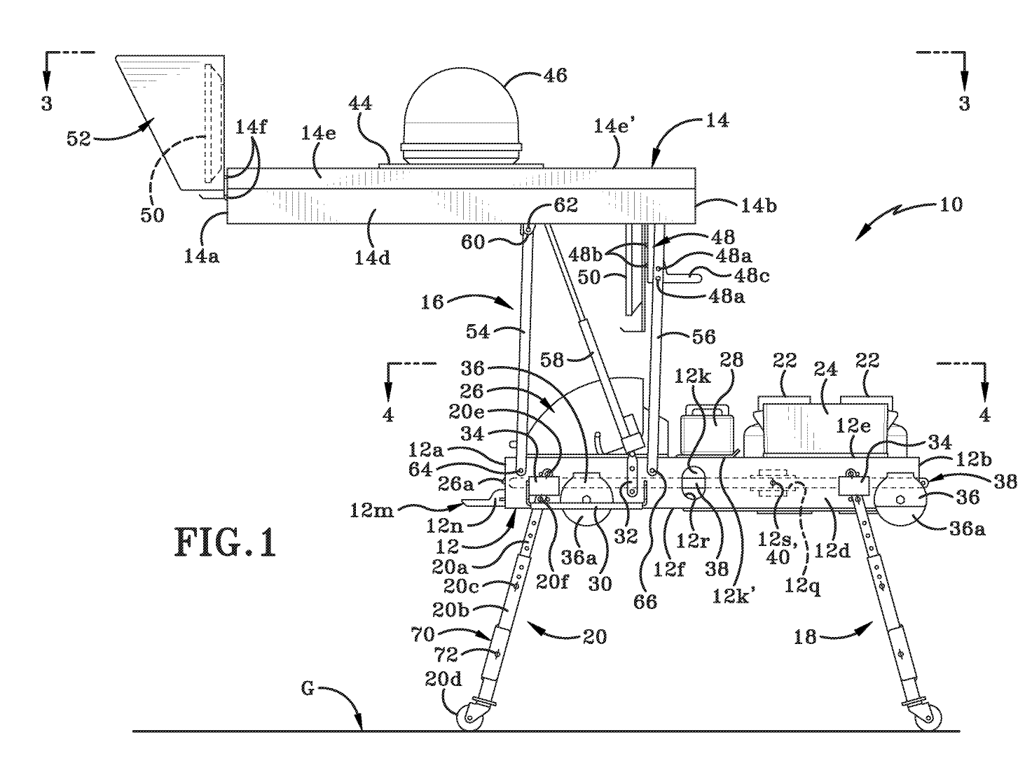

Referring to FIGS. 1-29, there is shown a mobile grilling unit in accordance with an aspect of the present disclosure. The mobile grilling unit will be referred to in the following description as the “unit” and will be indicated by the reference number 10.

Unit 10 may comprise a base 12 and a roof 14 that are oriented substantially parallel to each other. A pair of linkage assemblies 16 may be operatively engaged with each of the base 12 and roof 14 and may be used to raise, lower and generally adjust the position of roof 14 relative to base 12. Roof 14 remains substantially parallel to base 12 as roof is raised or lowered or is positioned in a position intermediate a fully raised or fully lowered position. Unit 10 may further comprise a pair of first legs 18 and a pair of second legs 20 that may be selectively detachably engaged with base 12. First legs 18 and second legs 20 may support base 12 a distance above a ground surface “G” (FIG. 1) when unit is utilized as a free-standing grilling unit. In other instances, legs 18 and 20 may be disengaged from base 12 when unit 10 is installed on a truck and is utilized for tailgating or when unit 10 is to be stored. The various uses, configurations and other details of unit 1 will be described in greater detail hereafter.

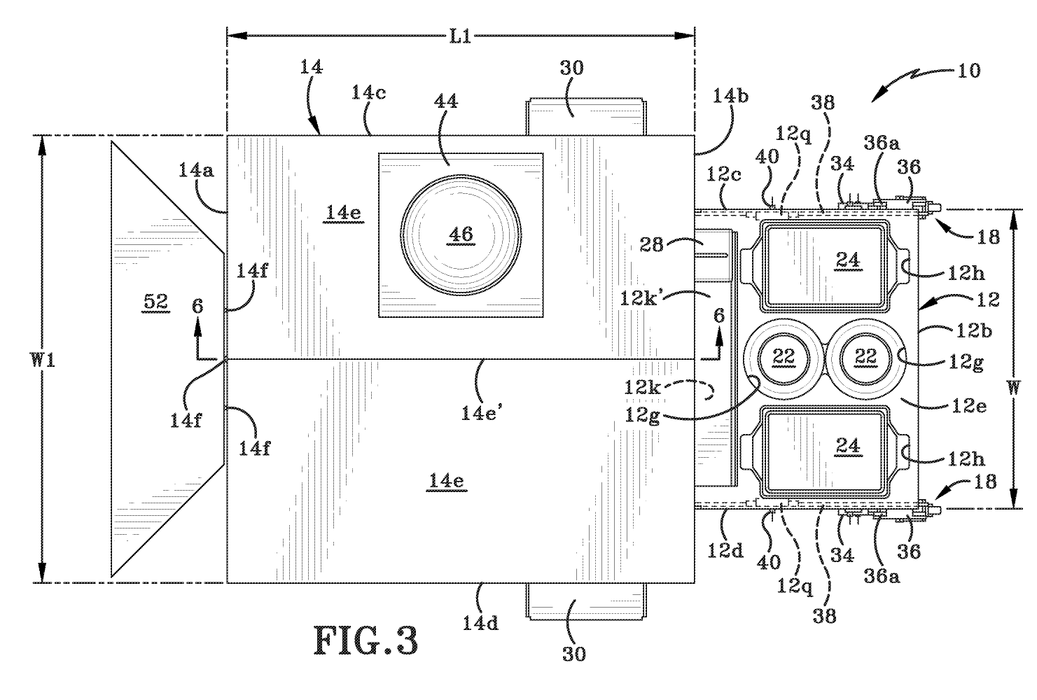

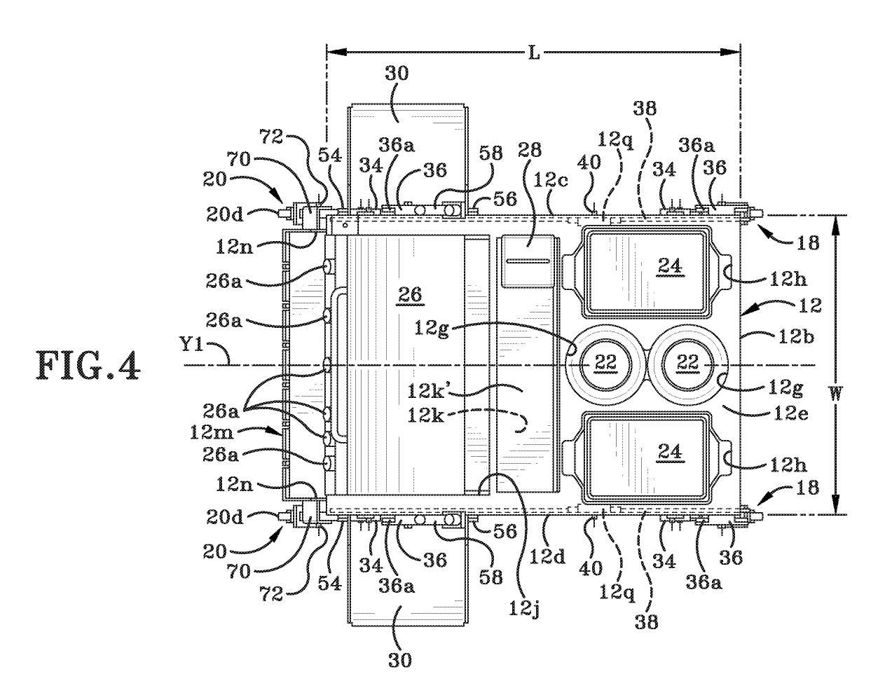

As is best seen in FIGS. 3, 4 and 5, base 12 may be a generally rectangular component that has a front end 12a, a rear end 12b, a left side 12c and a right side 12d. Base 12 may further comprise a top wall 12e and bottom wall 12f. Front and rear ends 12a, 12b and left and right sides 12c, 12d may form a peripheral wall that extends between top wall 12e and bottom wall 12f. Base 12 has a longitudinal axis “Y1” (FIG. 4) extending between front end 12a and rear end 12b and oriented at right angles relative to front and rear ends 12a, 12b. As shown in FIG. 4, base 12 may be of a length “L” and a width “W”. The length “L” and width “W” may be of a size suitable for unit 10 to be received within a truck bed, as will be later described herein.

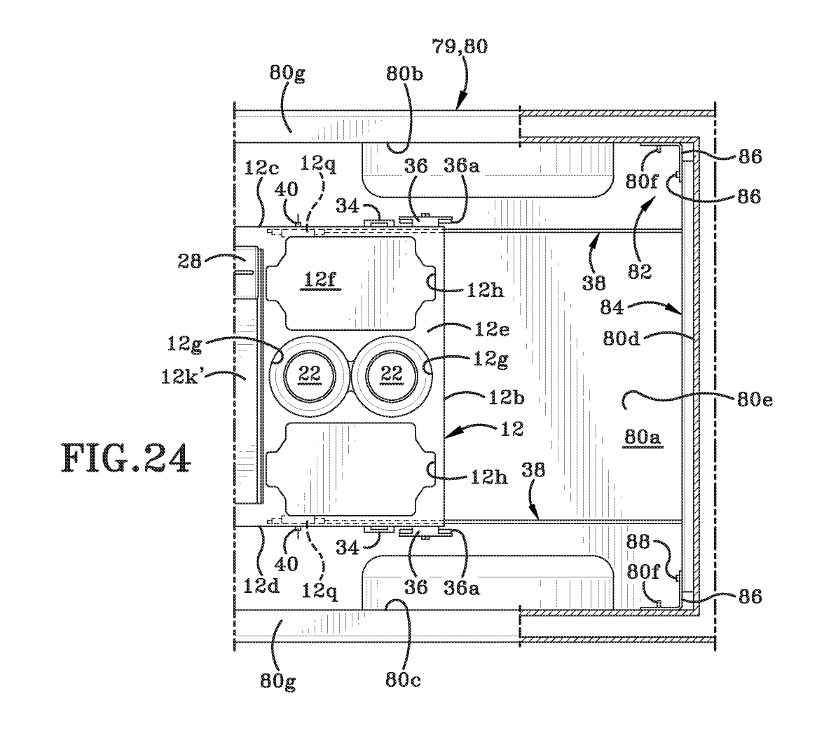

Top wall 12e may define a plurality of apertures therein. Each aperture may be specially configured to receive an accessory to unit 10 therein. These accessories may include but are not limited to, one or more fuel tanks 22 (preferably propane tanks), one or more coolers 24, and a barbeque grill 26 for grilling food thereon. FIGS. 3, 4 and 24 show fuel tanks 22 may be retained in specially shaped and sized apertures 12g; coolers 24 may be retained in apertures 12h (FIG. 24); and barbeque grill 26 may be retained in an opening 12j. Apertures 12g, 12h, 12j may be shaped and sized to be complementary to a particular region of the accessory to be received therein. Although not illustrated in these figures, it should be understood that in some instances a supporting member may be provided within the interior of base (i.e., between top wall 12e and bottom wall 12f) in order to more adequately receive and retain an accessory (such as each fuel tank 22) in place. It should further be noted that coolers 24 may be stackable coolers and only the lowermost of said stackable coolers may be received in the complementary aperture 12h. In some instances, an aligned aperture for receiving any of the accessories may also be defined in bottom wall 12f. The accessories may be retained in the associated aperture(s) by way of an interference fit, for example, fuel tanks 22 may be retained in aperture(s) 12g and coolers 24 may be received in aperture(s) 12h by way of an interference fit. In other instances, such as with the barbeque grill 26, fasteners or securing brackets may be additionally be utilized to hold the barbeque grill 26 in place.

Other accessories, such as a power pack 28 may also be supported and stored on base 12. Power pack 28 may be a rechargeable device that may be utilized to provide power to unit 10 and to various accessories used on or with unit 10. Power pack 28 or a vehicle trailer connector may therefore power the linkage assembly and other accessories. An extra connecting cable may be supplied with unit 10 and may be plugged into a truck hitch receptacle and be used to power the roof actuators or anything else that does not require AC110 current.

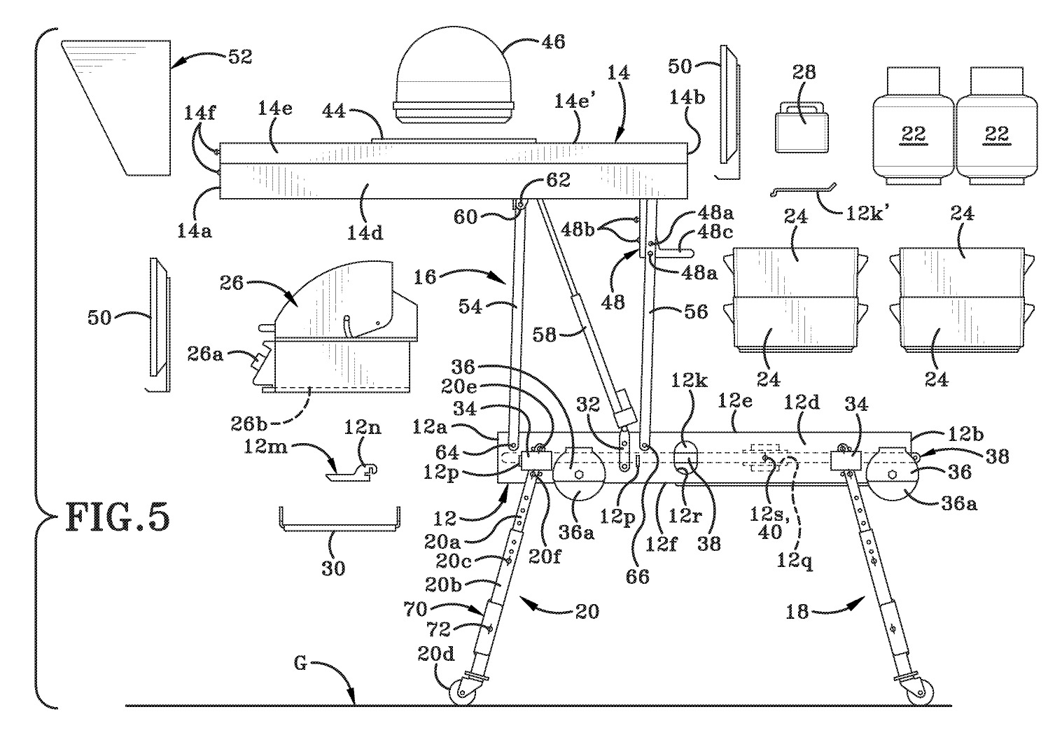

Base 12 may further define one or more compartments therein, such as compartment 12k (FIG. 4). Compartment 12k is formed by an aperture being defined in top wall 12e and a pair of opposed interior side walls extending between top wall 12e and bottom wall 12f. Compartment 12k is bounded and defined by the pair of interior side walls and a portion of bottom wall 12f. A door 12k′ (FIG. 5) may be pivotally engaged with one of the interior side walls and may be pivoted between an open position and a closed position. When in the closed position (FIG. 3), door 12k′ may extend across at least part of compartment 12k and be spaced a distance vertically above bottom wall 12f. Objects and implements such as power cords, lighters, gloves, barbeque brushes and tools, etc. may be stored within compartment 12k. When door 12k′ is pivoted to an open position these objects and implements may be accessed. When door 12k′ is pivoted to the closed position, the objects and implements are stored out of side. In other instances, one or more doors may be slidably engaged between interior side walls and may be slidably moved between an open position and closed position. As illustrated in FIGS. 1 and 3, other accessories, such as a power pack 28 may be stored on top of door 12k′.

In other instances, door 12k′ may terminate a distance away from one or the other of left side wall 12c or right side wall 12d, thereby creating an aperture into which power pack 28 may be received. In these instances power pack 28 may rest on bottom wall 12f and door 12k′ may be moved between open and closed positions as desired without requiring that power pack 28 be lifted out of position. It will be understood that door 12k′ may be provided with a locking mechanism or a latching mechanism in some instances.

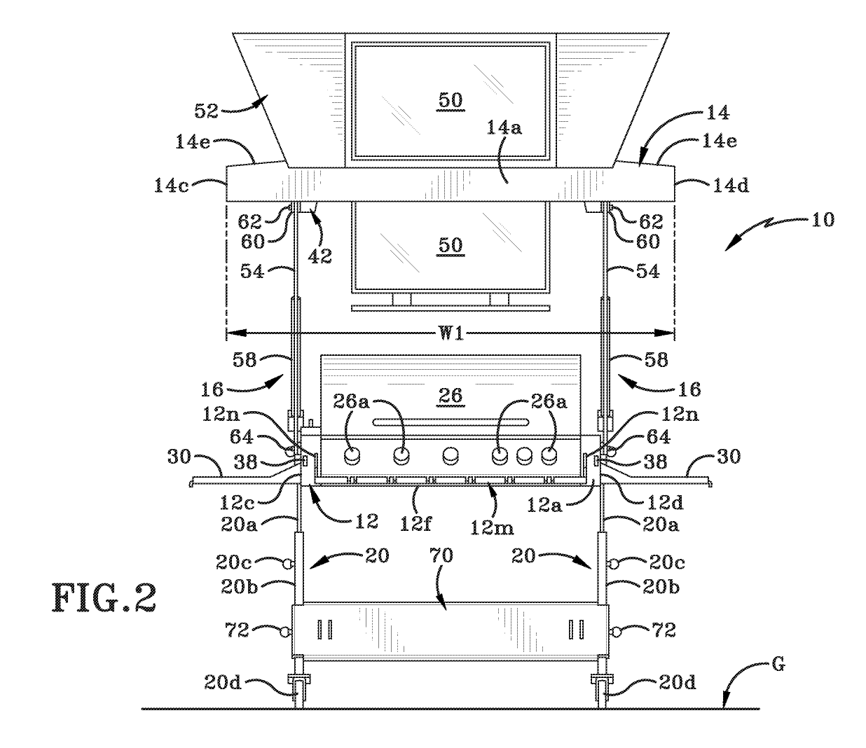

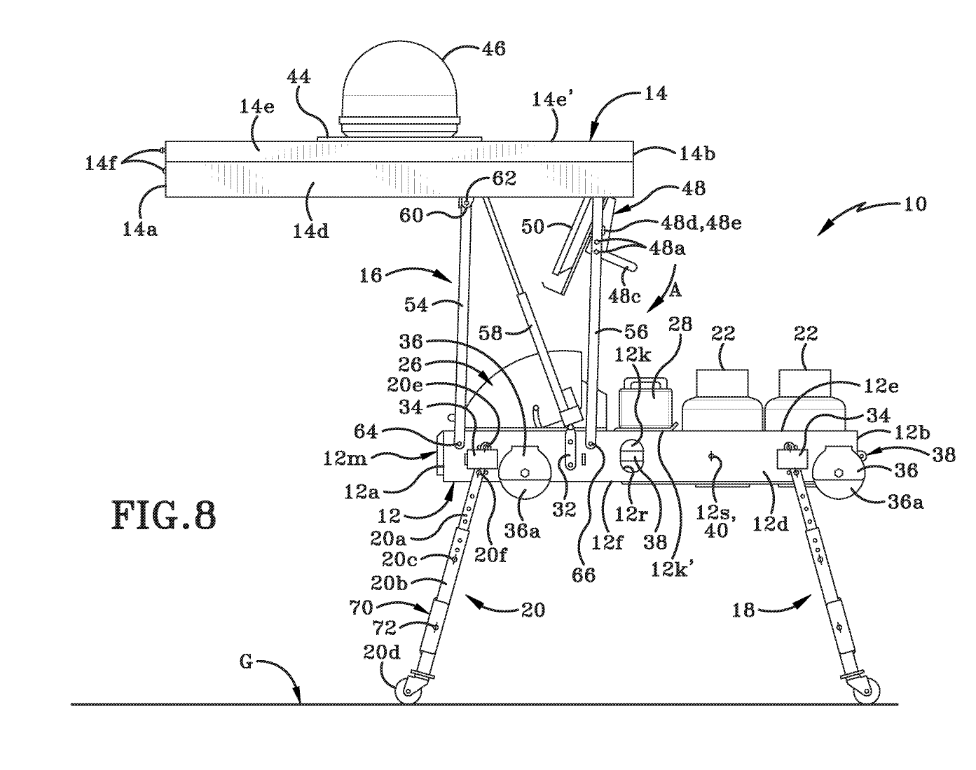

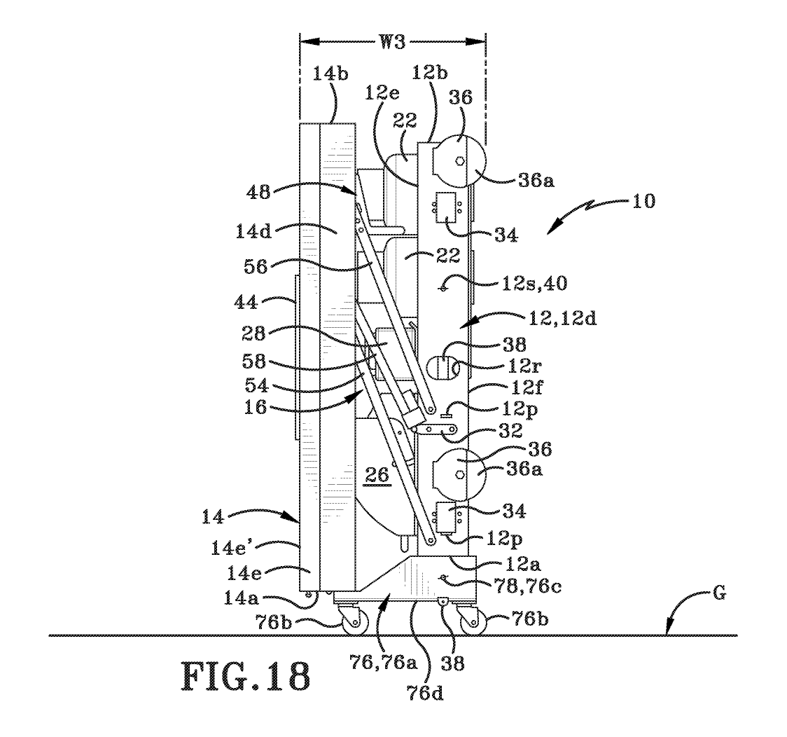

Base 12 may also define a receptacle adjacent front end 12a. In this instance, a door 12m may be hingedly engaged by brackets 12n (FIG. 5) to front end 12a (or to left and right sides 12c, 12d). Door 12m may be rotatable between an open position (FIG. 1) and a closed position (FIG. 8). The position of door 12m makes this location highly suitable for keeping tools at hand while cooking on barbeque grill 26. When door 12m is in the open position, barbeque tools, spices, or other tools or objects may be placed on the horizontally oriented interior surface of the door 12m. Additionally, when door 12m is moved to the open position then various control knobs 26a (FIG. 2) on barbeque grill 26 are visible and able to be used. When door 12m is moved to the closed position, door 12m is positioned in front of control knobs 26a, thereby preventing them from being seen or used. This feature may prevent a child from switching barbeque grill 26 on when nobody is looking. The closed door 12m may also aid in ensuring that the control knobs 26a are protected when unit 10 is moved from an erected position (FIG. 1) to a folded storage position (FIG. 18) or when unit 10 is being utilized or transported on a truck bed. Barbeque grill 26 may further include a drip pan 26b (FIG. 5). When door 12m is moved to the open position, drip pan 26b may be removed from barbeque grill 26 so that any grease may be discarded from drip pan 26b.

Base 12 is configured to permit a variety of other components of unit 10 to be engaged therewith. These other components may include linkage assemblies 16, first legs 18 and second legs 20, and one or more detachable shelves 30 (FIGS. 1 and 2). Left and right sides 12c, 12d may be fabricated to be mirror images of each other and may include a plurality of slots 12p (FIG. 5) defined therein, as well as one or more mounting brackets 32, 34, 36 that are secured thereto in any suitable manner. Slots 12p may be located and configured for selectively receiving projections from shelves 30 therein. When shelves 30 are to be mounted to base 12, the projections on shelves 30 are inserted into slots 12p. When shelves 30 are to be disengaged from base 12, the projections on shelves 30 are removed from slots 12p.

Mounting brackets 32 may be utilized to mount portions of each linkage assembly 16 to base 12. Mounting brackets 34 may be utilized to mount first legs 18 and second legs 20 to base 12. Each wheel mounting bracket 36 may be used to rotatably secure a wheel 36a to the associated one of left and right sides 12c, 12d.

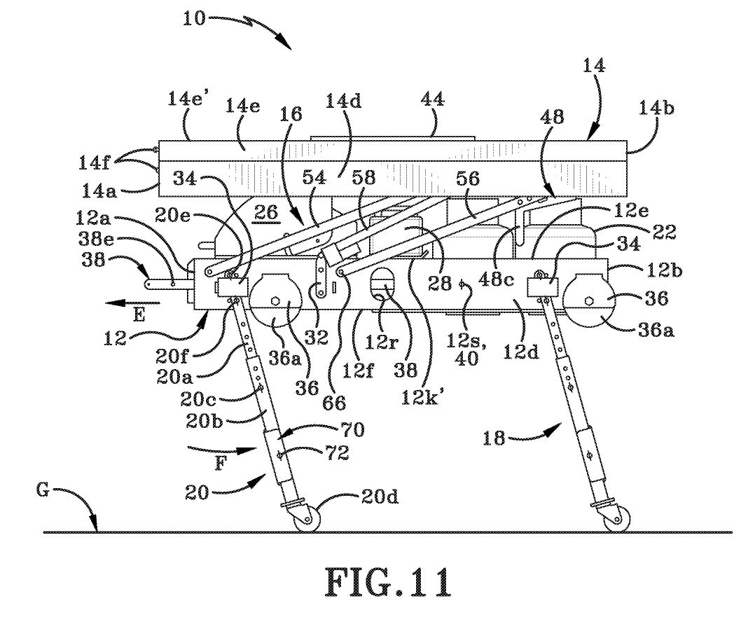

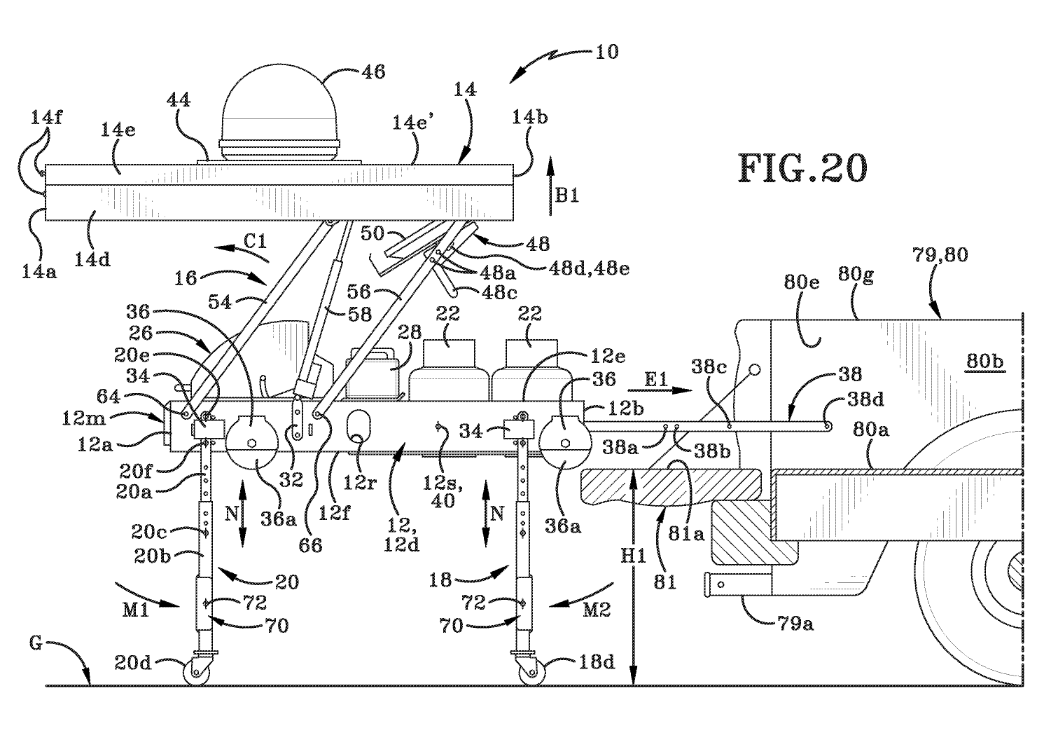

Base 12 may further define two spaced-apart pockets 12q (FIG. 2) that are accessible through slots defined in the front end 12a and rear end 12b. Each pocket 12q may originate in front end 12a proximate one or the other of left side 12c or right side 12d and may terminate in rear end 12b. A guide bar 38 (FIG. 1) may be received in each pocket 12q and may be at least partially slidable into and out of its associated pocket 12q. A first hole 12r and a second hole 12s may be defined in each of left side 12c and right side 12d. Guide bar 38 may be visible through first hole 12r. A pin 40 (FIGS. 1 and 3) may be selectively inserted through second hole 12s in order to be engaged in any one of a plurality of apertures 38a, 38b, 38c, 38d (FIG. 20) defined in guide bar 38. Pin 40 may be removed from second hole 12s to allow guide bar 38 to slide within pocket 12q. Pin 40 may be inserted into second hole 12s and into one of the plurality of apertures 38a, 38b, 38c, 38d defined in guide bar 38 in order to lock guide bar 38 in a particular position relative to base 12. (Guide bar 38 may also include an aperture 38e shown in FIG. 11. The purpose of aperture 38e will be described later herein.) In FIG. 1, guide bar 38 is received entirely within pocket 12q. In FIG. 20, guide bar 38 extends at least partially out of bar picket 12q and for a distance beyond rear end 12b.

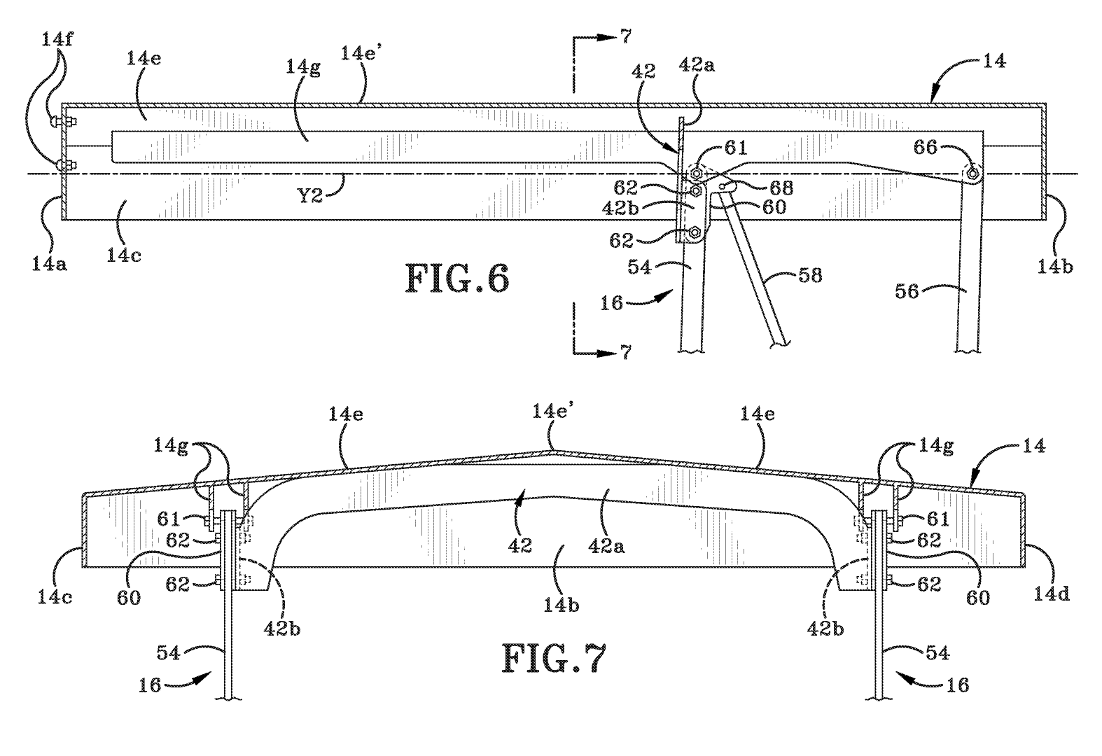

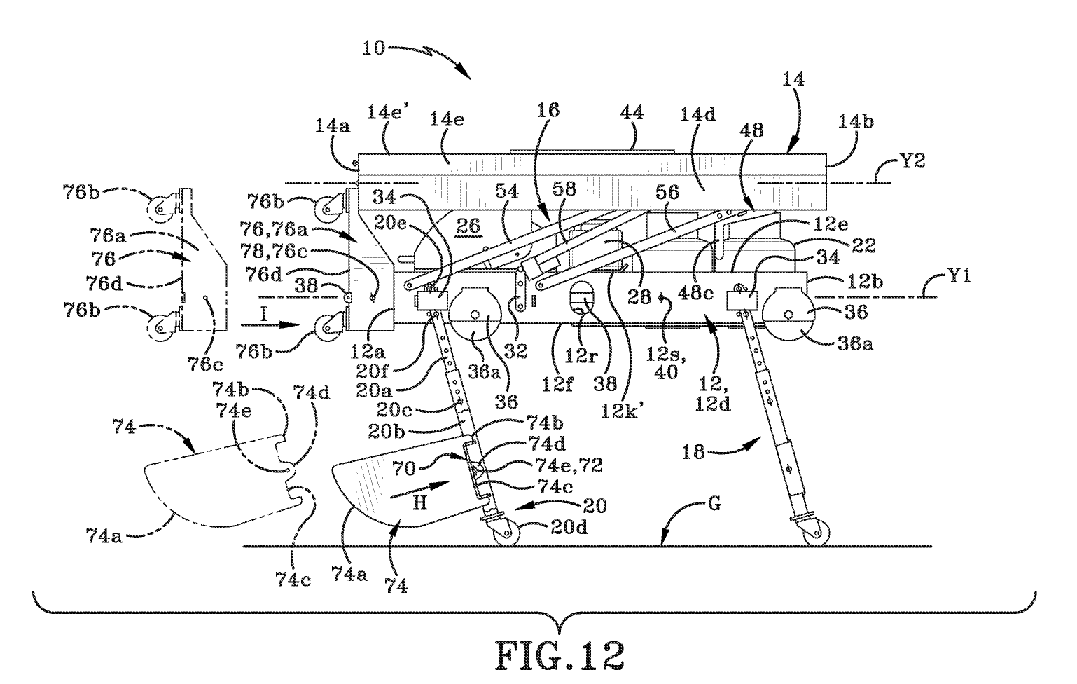

Roof 14 may be a generally rectangular component that includes a front end 14a, a back end 14b, a left side 14c (FIG. 2), a right side 14d, and a top wall 14e that extends between front and back ends 14a, 14b and left and right sides 14c, 14d. Roof 14 has a longitudinal axis “Y2” (FIGS. 6 and 12) that extends between front end 14a and rear end 14b and is oriented at right angles to front and rear ends 14a, 14b. As shown in FIGS. 3 and 7, top wall 14e may be V-shaped and have an apex 14e′ that is generally central to roof and runs from front end 14a to back end 14b. The V-shape of roof 14 will aid in ensuring that rain and other precipitation slides downwardly off roof 14 towards the left and right sides and not towards the front and back ends thereof. Roof 14 may be configured to overhang base 12 when positioned directly thereabove and has a length “L1” and a width “L2”. Length “L1” is greater than length “L” of base 12 and width “W1” is greater than width “W” of base 12

As shown in FIGS. 6 and 7, a pivotable support structure 42 may be engaged with linkage assembly 16 and with roof 14. Support structure 42 includes a cross-brace 42a and a flange 42b that is oriented at right angles to cross-brace 42a.

A satellite receiver mount 44 is provided on an exterior of top wall 14e of roof 14 and a satellite receiver 46 may be selectively engaged therein. A locking mechanism may be provided to lock satellite receiver 46 in place, particularly for occasions when unit 10 is engaged with a truck (as will be described later herein) that may then travel over the roads. A television mounting bracket 48 (FIGS. 1 and 5) may be provided for optionally mounting a television 50 to roof 14. Television mounting bracket 48 may be secured to linkage assemblies 16 by fasteners 48a and may be pivotable relative thereto between an extended position (FIG. 5) and a collapsed position. A television 50 may be engaged on connectors 48b (FIG. 50 provided on television mounting bracket 48. Television mounting bracket 48 may be moved between the extended and collapsed positions by grasping and manipulating an extension 48c (FIGS. 1, 5 and 8) provided on the mounting bracket 48. When television mounting bracket is moved to a collapsed position by being rotated in the direction indicated by arrow “A” in FIG. 8, television 50 may remain engaged therewith and may be retained beneath an interior surface of top wall 14e of roof 14. When it is desired to watch a show on television 50, mounting bracket 48 is rotated in the opposite direction to arrow “A” (FIG. 8) to move television 50 from a near-horizontal storage position under roof 14 to a near-vertical viewing position. Furthermore, in FIG. 8, the mounting bracket 48 with television 50 engaged therewith is tilted about an axis of rotation as defined by the lower fastener 48a. The upper fastener 48a is received by a radial slot (not shown) in the sidewall of 48 to limit travel of the engaged mounting bracket and television 48, 50 in a counterclockwise direction. When the mounting bracket and television 48, 50 is tilted in the direction of ‘A’ in FIG. 8, a cotter pin is inserted in the sidewall of 48 and engages the right vertical edge of support member 56 to hold the engaged mounting bracket and television 48, 50 in that position in preparation for lowering roof 14 to a storage or travel position.

An optional shroud 52 may be engaged on connectors 14f (FIG. 5) provided on front end 14a of roof 14. Front end 14a may include additional connectors 14f upon which television 50 may be mounted. It will be understood that a first television may be mounted on television mounting bracket 48 and the first television 50 or a second television may be mounted on connectors 14f. Shroud 52 may be engaged with roof to shield television 50 from sun, wind and precipitation. Since shroud 52 has both a roof section and side sections, shroud 52 may also cut down on the glare on the television screen.

Roof 14 includes a pair of spaced-apart support bars 14g that extend downwardly from an interior surface of roof 14. As indicated earlier herein, a pair of linkage assemblies 16 engage base 12 and roof 14 to each other. Each linkage assembly 16 may include a first support member 54, a second support member 56 and an actuator 58. Actuator 58 may be a threaded rod 58a and matingly threaded cylinder 58b that are electrically activated to either extend rod 58a further out of cylinder 58b or to withdraw to 58a into cylinder58b. In other instances, actuator 58 may be a pneumatic cylinder or a hydraulic cylinder.

A first end of each first support member 54 and each second support member 56 is pivotally mounted to a region of support bars 14g extending downwardly from roof 14. A second end of each first support member 54 and each second support member 56 is also pivotally mounted to a region of base 12; particularly to one of the left side 12c or right side 12d. As can be seen in FIGS. 6 and 7, a mounting bracket 60 is engaged via a pin 61 to each support bar 14g. Mounting bracket 60 may be U-shaped and the first end of first support member 54 may be received between the arms of the u-shaped mounting bracket. Pins 52 secure first support member 54 and the flange 42b of support structure 42 to mounting bracket 60. A fastener 66 (FIG. 1) secures the second end of each first support member 54 to base 12. When linkage assembly 16 is actuated, support structure 42 is pivoted in unison with first support members 54. Additional fasteners 66 secure each of the first and second ends of second support member 56 to support structure 42 and to base 12. A first end of each actuator 58 is secured by a fastener 68 (FIG. 6) to first support member 54 and thereby to mounting bracket 60 and support structure 42. A second end of each actuator 58 is secured by fasteners to mounting bracket 32 provided on base 12.

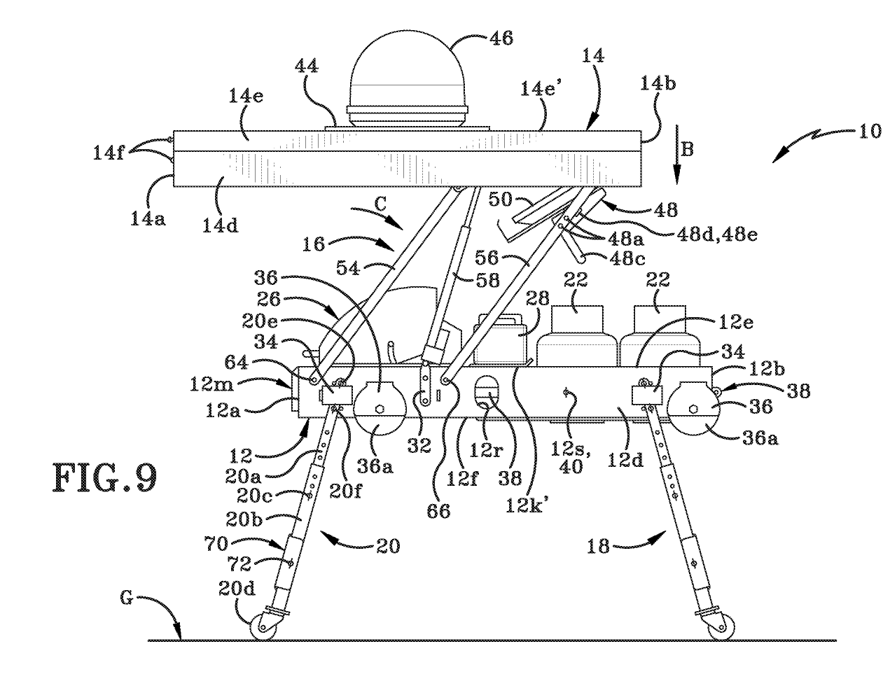

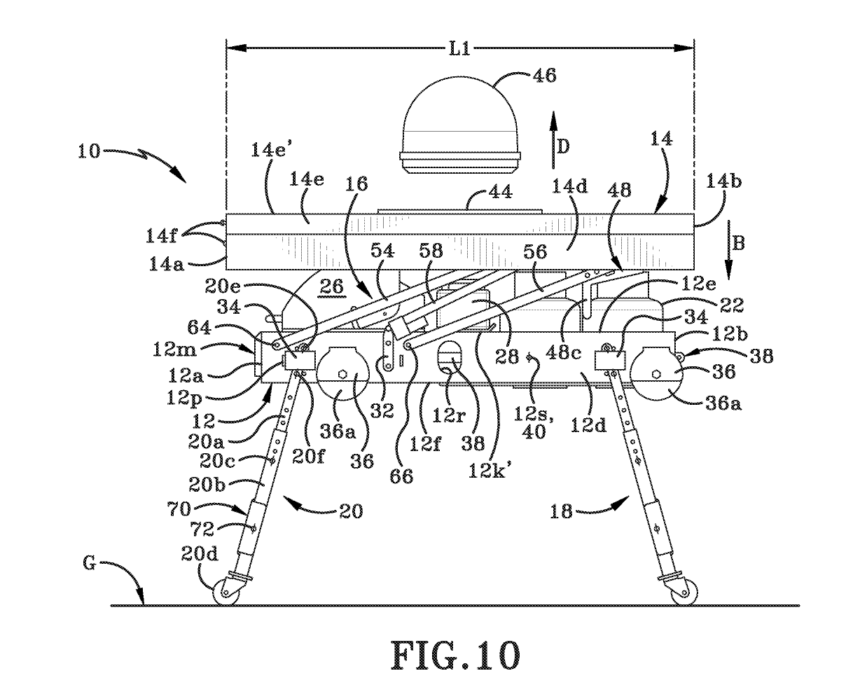

Actuator 58 includes a rod 58a and a cylinder 58b. When rod 58a is withdrawn into cylinder 58b, roof 14 is moved downwardly in the direction of arrow “B” (FIG. 9) and first and second support members 54, 56 and actuator 58 are rotated in the direction of arrow “C” (FIG. 9). The movements in the directions “B” and “C” move the roof towards a collapsed position shown in FIG. 10. When the rod 58a is extended further outwardly from cylinder 58b, first and second support members 54, 56 and actuator 58 move in the opposite direction to arrow “C” and roof 14 is moved in the opposite direction to arrow “B”. The roof is therefore movable between the collapsed position (FIG. 10) to the erected position (FIG. 1). It should be noted that linkage assembly 16 may be actuated to raise and lower roof 14 relative to base 12. The specific distance between roof 14 and base 12 may be selected by simply stopping the motion of actuator at the fully erected or fully collapsed positions or somewhere therebetween. It should be noted that when roof 14 is in the fully extended position, only a rear region of roof 14 is positioned vertically above base 12. The rest of the roof 14 is positioned forwardly of the front end 12a of base. This can be seen in FIG. 1. When roof 14 is in this position, a person standing in front of barbeque grill 26 will be standing under part of roof 14 and will be protected thereby from rain and sun. When roof 14 is moved to the collapsed position, roof 14 is positioned over base 12 and base 12 is entirely covered by roof 14. In fact, because roof 14 is longer and wider than base 12, roof 14 extends outwardly beyond front end 12a, rear end 12b, left side 12c and right side 12d of base 12. This can be seen in FIG. 10 and can be inferred from FIG. 3. In this position roof 14 becomes the truck bed cover.

It should be understood that the linkage assemblies 16 preferably have to function in unison in order to insure smooth raising and lowering of roof 14 relative to base 12. Linkage assemblies 16 may be activated electronically. Power pack 28 may be utilized to provide direct current (DC) to activate actuators 58 and thereby initiate raising or lowering of roof 14. In other instances or in case power pack 28 has run out of power, activation of linkage assemblies 16 may be accomplished by a user manually pushing or pulling roof 14. Additionally, the power cord running from the switch to the power pack may be exchanged with one supplied to run from the switch to the truck rear hitch wiring connector.

Power pack 28 may also provide current for TV 50, satellite receiver 46 and any other electrical appliances that the user may select to utilize on unit 10. Power pack 28 may also be used to perform other tasks like charging cell phones. It will be understood that unit 10 may be provided with appropriate circuitry to connect the various components needing power to power pack 28. Such circuitry has been omitted from the attached drawings for ease of illustrations. Electrical switches to operate power pack 28 or various accessories on unit 10 are provided on base 12 or roof 14 and circuit breakers are also be provided in the unit's circuitry.

First and second legs 18, 20 are substantially identical in structure and may therefore be engaged with any of the mounting brackets 34 provided on base 12. Since legs 18, 20 are all substantially identical, only one of the legs 20 will be further described herein. Leg 20 preferably is constructed to telescope and includes a first section 20a that is slidably receivable within a bore defined in a second section 20b. Each of the first section 20a and second section 20b is provided with a plurality of spaced-apart apertures defined therein. First section 20a may be pulled out of or pushed into the bore of second section 20b to adjust the overall length of leg 20. One or more apertures in first section 20a are aligned with one or more apertures in second section 20b and a pin 20c is inserted through each pair of one or more aligned apertures to lock leg 20 at a particular length. A caster 20d is provided at one end of leg 20. A locking mechanism may be provided on caster 20d to selectively prevent the caster from rotating. The opposite end of leg 20 is secured to mounting bracket 34 in any appropriate manner such as by utilizing pins 20e, 20f that are selectively engageable with different holes in left and right sides. If it is desired to remove leg 20, pins 20e, 20f are disengaged from base 12 and leg 20 and leg 20 is withdrawn from between mounting bracket 34 and left side or right side of base 12. If it is desired to engage leg 20 with base 12, the opposite end of leg 20 is inserted into a space defined between mounting bracket 34 and the left or right side of base 12. Pins 20e, 20f are inserted through holes in leg 20 to prevent withdrawal of the opposite end of leg 20 from the space between mounting bracket 34 and the left or right side of base 12.

A brace plate 70 may be engaged with each of the second legs 20 so that brace plate 70 spans the gap between the two legs 20. Brace plate 70 includes one or more apertures therein that are selectively alignable with one or more apertures defined in second section 20b of each second leg 20. One or more pins 72 are inserted through the aligned apertures in brace plate 70 and second legs 20. Brace plate 70 provides strength and stability to the pair of second legs 20. As is shown in FIG. 1, a second brace plate is also engaged with the pair of first legs 18 in a similar fashion.

Roof 14 may be lowered into the position shown in FIG. 10 when unit 10 is not being used. Positioning roof 14 over base 12 in this manner protects all of the accessories from being contacted by precipitation and from the sun. If it is desired to use unit again, then roof is simply raised by activating the actuator to move linkage assembly 16 in the opposite direction to arrow “C” and thereby to move roof 14 in the opposite direction to arrow “B”.

In other instances, however, it may be desirable to fold unit 10 into a storage position and to put unit away in vertical storage for a period of time. The folding of unit 10 into a storage position is illustrated in FIG. 9 through to FIG. 18. Prior to moving unit 10 to the storage position, it is advisable to remove the drip tray 26b (FIG. 5) from barbeque grill 26 and clean the same. It is also advisable to remove coolers 24 from base 12 or at least remove any foodstuffs or drinks from coolers 24 and cleaning and drying the coolers 24 prior to placing them back into base 12. It is, however, suggested that coolers 24 not be engaged with unit 10 when unit 10 is going to be vertically stored. Storing a cooler 24 that is not properly cleaned and dried may result in a cooler 24 that becomes moldy and unsafe for use. Removal of LP tanks is also necessary to prevent leakage or internal damage to the tanks.

Once unit 10 is cleaned up and ready for storage, in a first step toward folding and storing unit 10 and as shown in FIGS. 9 and 10, roof 14 is moved in the direction of arrow “B” into the collapsed position relative to base 12 as has been described above, Satellite receiver 46 is then disengaged from satellite receiver mount 44 and is moved away from roof 14 in the direction of arrow “D”.

Each guide bar 38 is then moved out of its associated pocket 12q in the direction of arrow “E”. Before this can occur, the associated pin 40 has to be removed from the aperture 12s defined in unit 12. Guide bar 38 is pulled out of pocket 12q to the point that a section or guide bar 38 extends forwardly from front end 12a of base 12 and so that one of the apertures, 38e, is made available. Aperture 38e may be located a short distance from the terminal end of guide rail 38. Additionally, base12, roof 14 and legs 18, 20 may be moved relative to each other so that legs 18, 20 are effectively pivoted slightly in the direction of arrow “F”. This movement in the direction of arrow “F” is limited to the extent that legs 18, 20 still have to support base 12 and roof 14 a distance above ground “G”.

As is indicated in FIG. 12, a roll plate 74 may be engaged with each second leg 20 and with brace plate 70 and pin 72. Roll plate 74 may include an arcuate end 74a that will ultimately be placed in contact with the ground surface “G”. An end 74b of roll plate 74 opposite arcuate end 74a defines a U-shaped recess 74c therein that is complementary in size to a region of brace plate 70. Roll plate 74 may also include a tab 74d that extends outwardly into recess 74c. Roll plate 74 is moved in the direction of arrow “H” (FIG. 12) and is positioned so that recess 74c captures a region of that end of brace plate 70 therein and such that aperture 74e is aligned with the apertures in brace plate 70 and second leg 20 from which pin 72 was withdrawn. Pin 72 is then reinserted into the aligned apertures in tab 74d, brace plate 70 and second leg 20. The pin 72 engaged with the other end of brace plate 70 and the other second leg 20 is then removed and a second roll plate 74 is positioned so that the recess 74c therein captures the opposite end of brace plate 70. The aperture 74e in the second roll plate 74 is aligned with the apertures in brace plate 70 and the other second leg 20 from which pin 72 was withdrawn. The pin 72 is then inserted into the aligned apertures to secure the second roll plate 74 to unit 10. When the two roll plates 74 are engaged with unit 10, as is illustrated in FIG. 12, the roll plates 74 are oriented substantially parallel to a longitudinal axis “Y1” of unit 10 (where the longitudinal axis “Y1” extends between first end 12a and second end 12b of base 12). Roll plates 74 are also oriented at right angles to brace plate 70.

Additionally, as is illustrated in FIG. 12, a wheel assembly 76 is engageable with the front end 12a, 12m of base 12 and with the front end 14a of roof 14. Wheel assembly 76 comprises a carriage 76a with a plurality of casters 76b mounted thereon. Carriage 76a is configured to be complementary to front ends 12a/12m, 14a and is of a greater width in the region that engages base 12 than in the region that engages roof 14. A pair of aligned holes 76c is defined in opposite side walls of carriage 76a. Carriage 76a also defines a pair of spaced-apart slots in a bottom wall 76d thereof. The slots are positioned so that the ends of the two guide bars 38 that extend forwardly from base 12 may be received into the slots when wheel assembly is moved toward unit 10 in the direction of arrow “I”. When wheel assembly 76 is in engagement with base 12 and roof 14, each guide bar 38 is moved into a position where the aperture 38e therein is aligned with one of the holes 76c in a side of wheel assembly 76. A pin 72 may then be inserted through the aligned hole 76c and aperture 38e. These two pins 78 help secure wheel assembly 76 to unit 10. Additionally, a pin 72 is inserted through the associated aperture 12s in left or right sides 12c, 12d of base 12 and into an aligned aperture 38a, 38b, or 38c defined in guide bar 38. This ensures that wheel assembly 76 is tightly retained in engagement with unit 10.

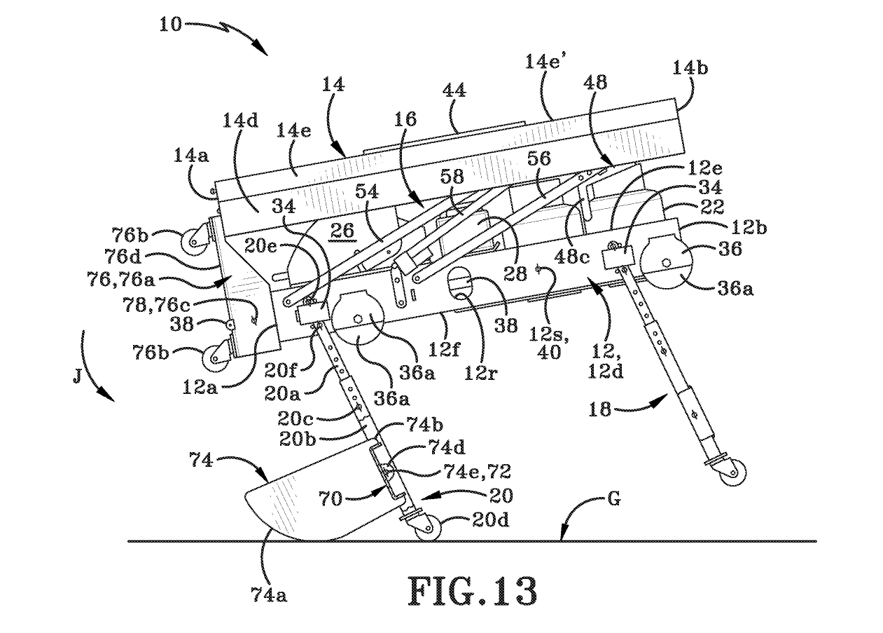

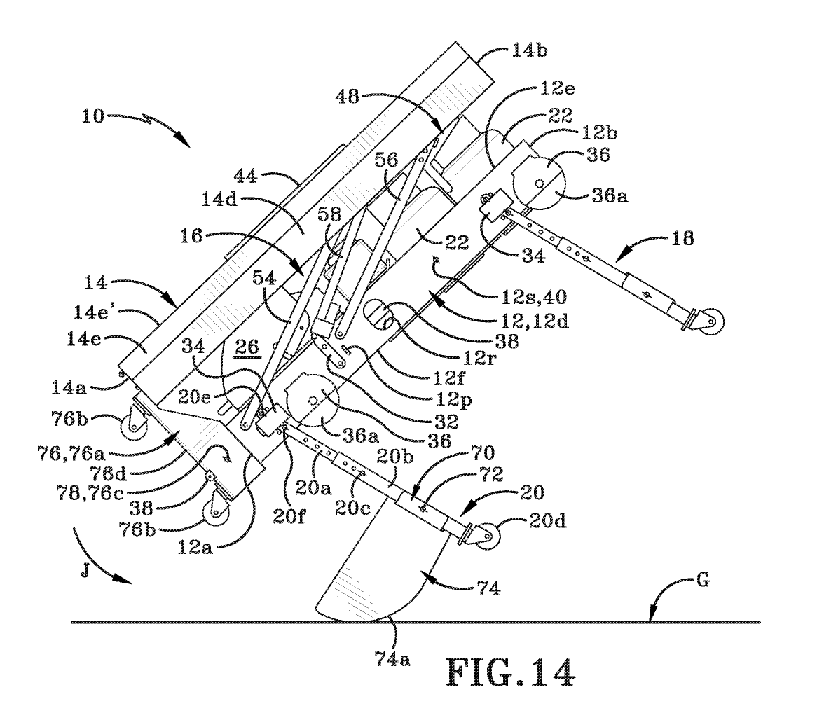

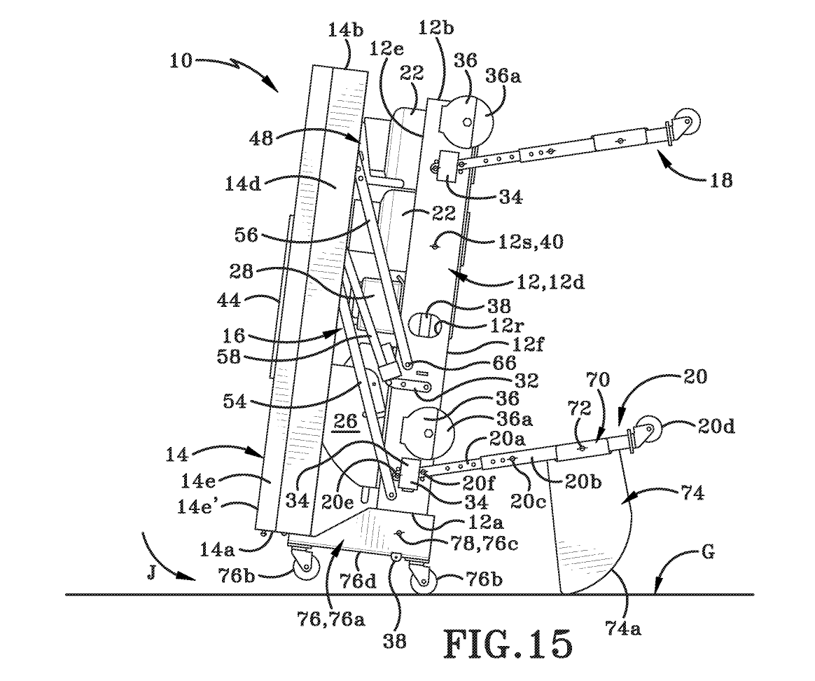

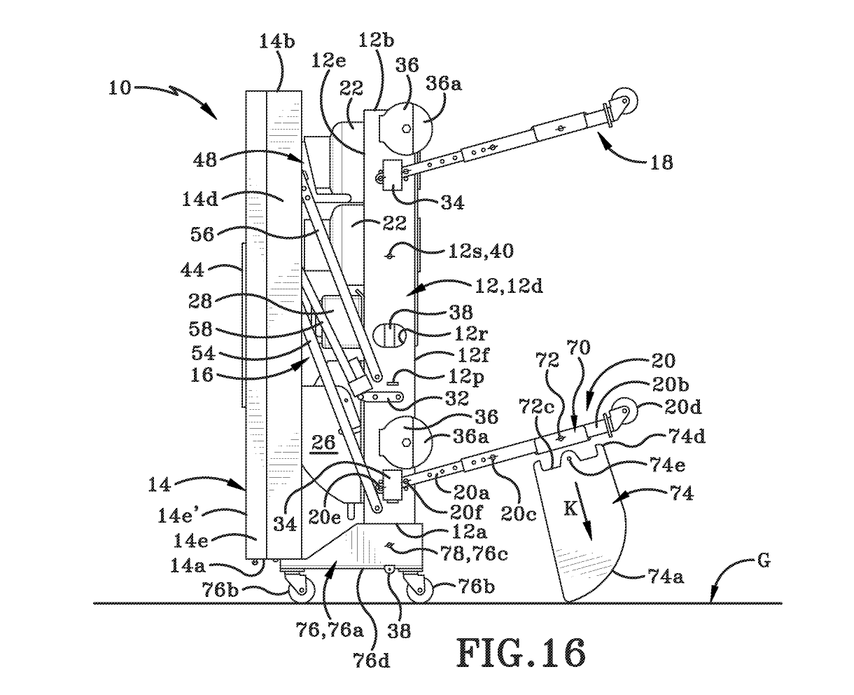

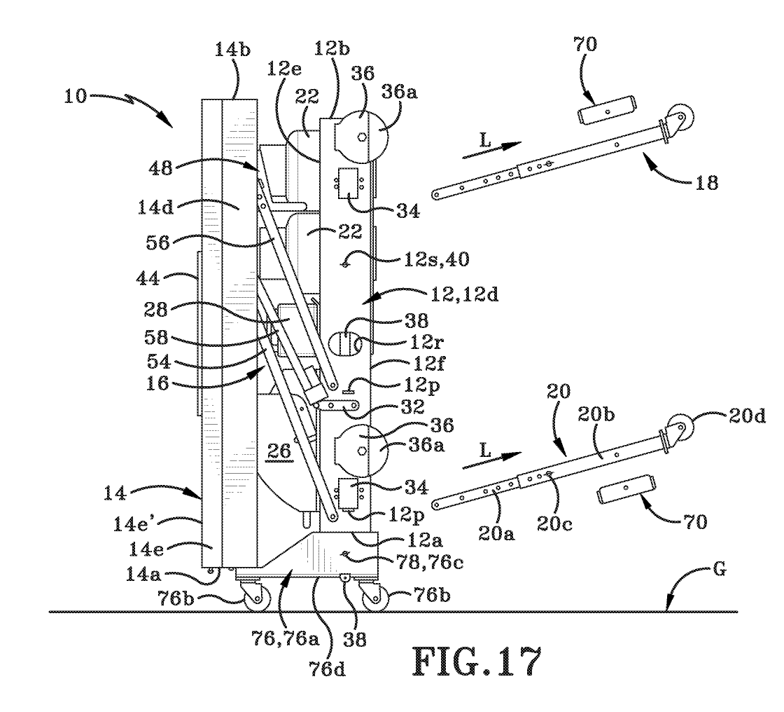

Unit 10 may then be rotated in the direction of arrow “J” (FIG. 13) so that the arcuate ends 74a of the two roll plates 74 may contact ground “G”. Legs 18 may be lifted off ground “G” at this point. Continued rotation in the direction of arrow “J” (shown in FIGS. 14 and 15) causes the casters 20d to be lifted off the ground “G” and, initially, unit 10 is supported on one pair of the casters 76b on wheel assembly 76 and on the two roll plates 74. Ultimately, all the casters 76b on wheel assembly 76 contact ground “G” as is illustrated in FIG. 16. At this point, roll plates 74 are disengaged from legs 20 by disengaging the associated pin 72 and moving roll plates 74 in the direction indicated by arrow “K” (FIG. 16). Each pin 72 is then re-engaged with brace plate 70 on the associated one of the legs 20. Legs 18, 20 are then disengaged from base 12 and are removed therefrom as indicated by arrows “L” in FIG. 17. FIG. 18 shows unit 10 in the upright position where longitudinal axes “Y2”, “Y1” of roof 14 and base 12 are oriented substantially vertically and at right angles to ground “G”.

Unit 10 is also shown in FIG. 18 to be of a width “W3”. When unit 10 is moved from the free-standing position shown in FIG. 10 to the vertical storage position shown in FIG. 18, the overall footprint of unit 10 on the ground is substantially reduced. In FIG. 10, unit 10 effectively has an overall length that is the length of roof 14; i.e., length L1″. Unit 10 also has an overall width that is the width of roof 14; i.e., width “W1” (as shown in FIG. 3). When unit 10 is moved to the storage position, however, the overall length of unit 10 is the distance between left side 14c and right side 14d of roof; i.e., the equivalent of the width “W1”. This distance is less than the length “L1”. Furthermore, when unit 10 is in the storage position, the width “W3” of unit 10 is measured between the apex 14e′ of roof 14 and an outermost edge of wheels 36a. This width “W3” is less than the width “W1” of roof. Consequently, turning unit 10 up on one end substantially reduces the amount of storage space required to accommodate unit 10.

Casters 76b on wheel assembly 76 enable a user to wheel unit 10 in the storage position across the ground “G” to any desired storage location. It should be noted that some or all of the accessories such as barbeque grill 26 and power pack 28 may be retained between base 12 and roof 14 during storage of the unit 10 in the above-described manner. It should also be noted that a grill grate retention kit may also be utilized prior to tipping unit 10 to its vertical storage position. This kit helps to retain the grill grates in place and prevents them from falling out of their correct position when unit 10 is tipped.

When it is later desired to use unit 10 again, the user will simply retrieve unit 10 from its vertical storage location and wheel the unit across ground “G” on casters 76b to a location where it can be returned to the free-standing position or to a location where it may be installed on a truck bed, as will be described later herein. Returning unit 10 from the vertical storage position to the free-standing position shown in FIG. 9 simply requires that the steps “B” through “L” described above be reversed. Once unit 10 is back in the free-standing position shown in FIG. 9, roof 14 may be raised away from base 12 using linkage assembly 16 as previously described and unit 10 is then ready for use.

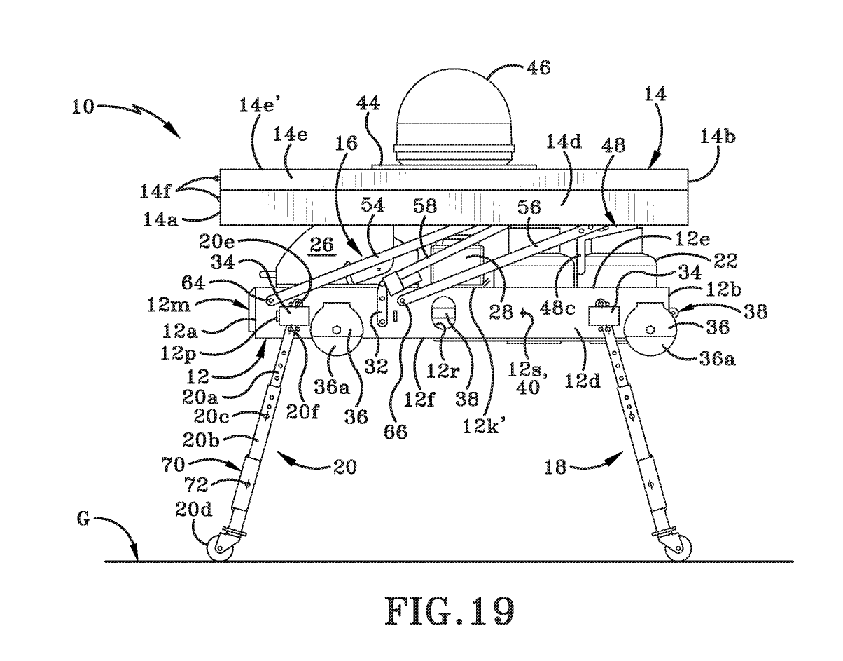

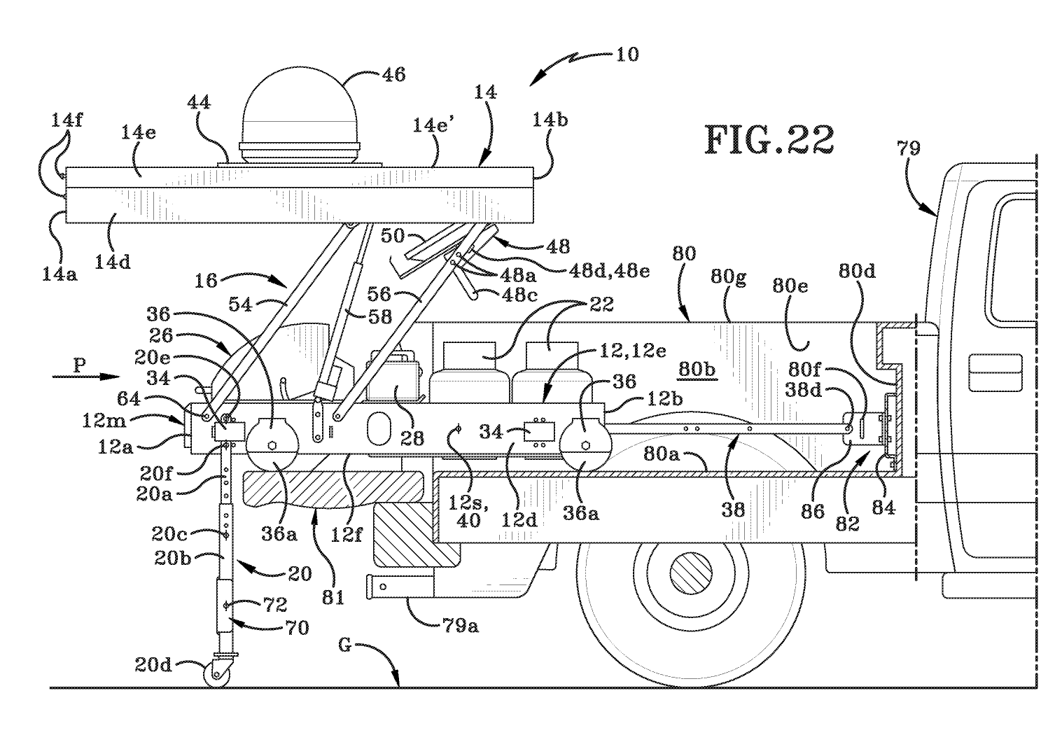

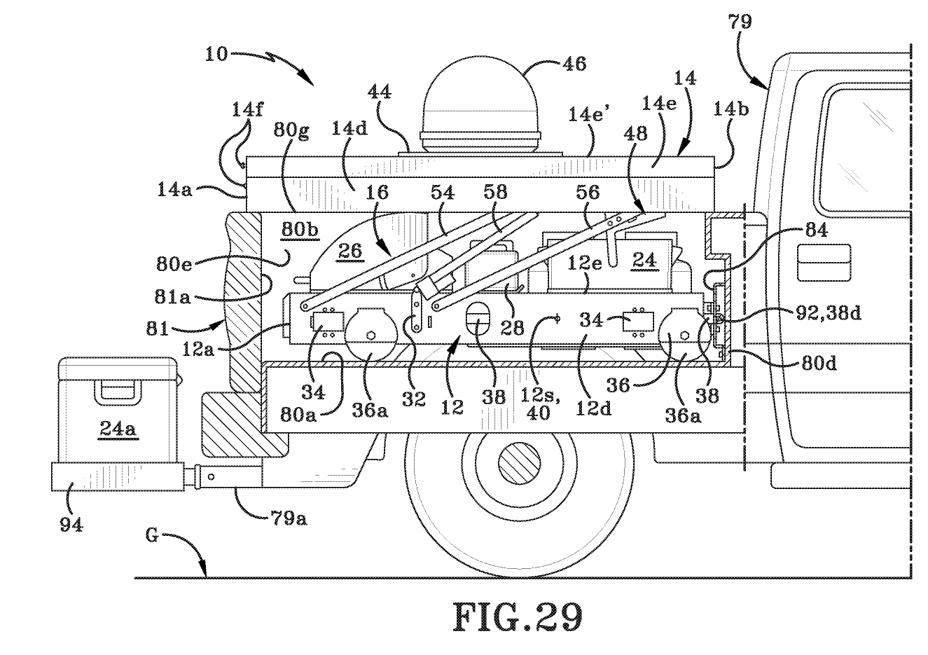

In other instances, it may be desirable to engage or install unit 10 on a truck 79. The engagement and use of unit 10 on a truck 79 is illustrated in FIG. 19 through to FIG. 29. Truck 79 includes a truck bed 80 and a tailgate 81 that is pivotable relative to truck bed 80. Truck bed 80 includes a floor 80a, a left side wall 80b, a right side wall 80c, and a bulkhead 80d. Bulkhead 80d is opposed to tailgate 81 when tailgate 81 is in a closed position. A cavity 80e is defined by bulkhead 80d, tailgate 81, and left and right side walls 80b, 80c. A ring member 80f (FIG. 22) extends into cavity 80e from each of left and right side walls 80b, 80c. Bulkhead 80d, left and right side walls 80b, 80c have upper ends that define a rim 80g. When unit 10 is engaged on truck 70, the unit 10 may be received partially on an upper surface 81a of tailgate 81 and partially on floor 80a of truck bed 80 or may be received entirely on floor 80a, as will be described further herein.

FIG. 19 shows unit 10 in a free-standing braked position, supported on legs 18, 20. Legs 18, 20 must be moved to their vertical position before rolling unit 10. Unit 10 is then movable on casters 20d, 18d across ground “G” until rear ends 12b, 14b of base 12 and roof 14 are proximate tailgate 81 of truck 79. Legs 18, 20 may be pivoted in the directions indicated by arrows “M1” and “M2” until they are oriented substantially vertically relative to ground “G”. Legs 18, 20 may also be telescoped up or down as necessary (and as indicated by arrows “N”) until wheels 36a on base 12 are at a height “H1” from the ground “G”. At height “H1”, the bottoms of wheels 36a are positioned on the same or a near plane as the upper surface 81a of the open tailgate 81. The adjustment of legs 18, 20 to the height “H1” makes it possible for wheels 36a to roll onto surface 81a of tailgate 81 and ultimately onto floor 80a of truck bed 80.

As shown in FIG. 20, roof 14 may be raised in the direction “B1” away from base 12 by linkage assembly 16 pivoting in the direction “C1”. The raising of roof 14 may not be necessary but it makes it easier to access guide bars 38. The two guide bars 38 are withdrawn from their associated pockets 12q in the direction of arrow “E1” until they extend for a distance rearwardly of rear end 12b of base 12.

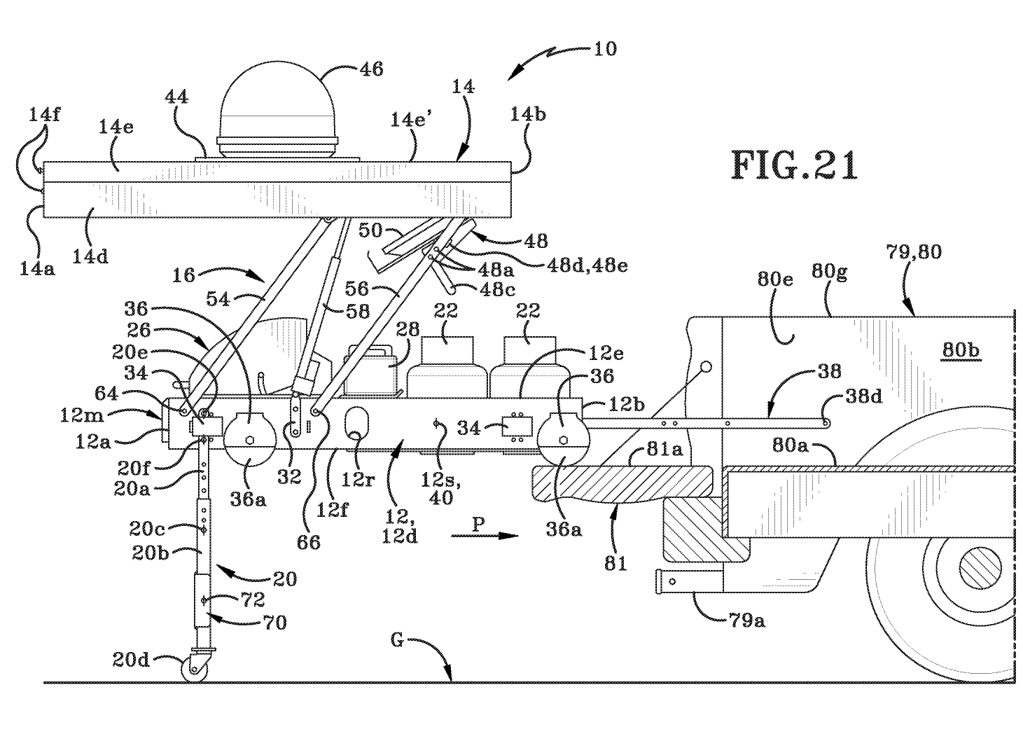

Unit 10 is moved on casters 18d, 20d in the direction of arrow “P” (FIG. 21) until the wheels 36a proximate rear end 12b of unit 10 come to rest on surface 81a of tailgate 81. At this point, first legs 18 are disengaged from unit 10. Unit 10 is thus supported on wheels 36a that are in contact with tailgate 81 and on casters 20d which are in contact with ground surface “G”. This is illustrated in FIG. 21.

Unit 10 is then moved toward bulkhead 80d on wheels 36a and on casters 20d in the direction of arrow “P” until the wheels 36b proximate front end 12a of base 12 come to rest on upper surface 81a of tailgate 81. At this point, unit 10 is supported by wheels 36a, 36b that are in contact with tailgate 81 and floor 80a of truck bed 80 as well as casters 20d which are in contact with ground surface “G”. This is shown in FIG. 22.

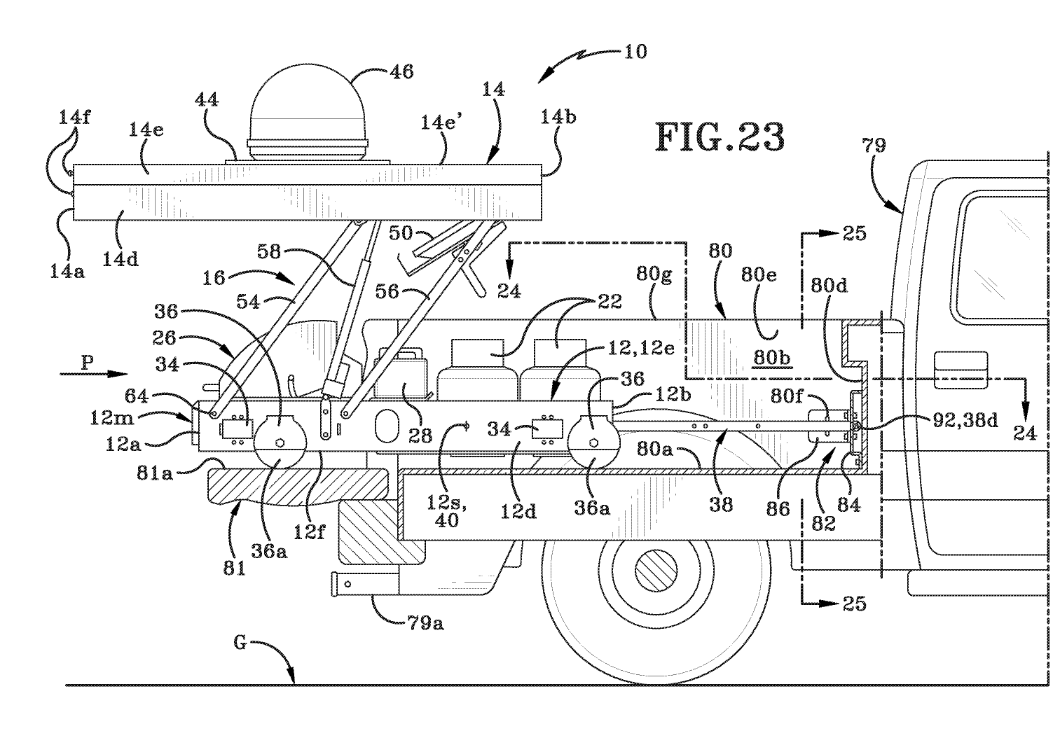

Guide bars 38 (FIG. 23) are, at this point, secured to truck mounting assembly 82. Truck mounting assembly 82 is shown in greater detail in FIGS. 24, 25 and 26. Mounting assembly 82 comprises a mounting plate 84 and a pair of L-shaped mounting brackets 86. Various types of mounting brackets 86 may be utilized to secure mounting plate 84 to different brands of trucks as the design of the truck bed 80 varies from one brand of vehicle to another. It will be understood that the specific truck 79, truck bed 80 and mounting bracket 86 illustrated in the attached figures are by way of example only. Mounting plate 84 is placed against bulkhead 80d and one leg of each mounting bracket 84 is placed mounting plate 84 and the other leg of each mounting bracket 84 is placed against one of the left or right side walls 80b, 80c. Each mounting bracket 84 is positioned so that ring member 80f extends through a slot defined on the mounting bracket 84. Fasteners 88 are used to secure mounting brackets 86 and mounting plate 84 to side walls 80b, 80c and to bulkhead 80d. Additional fasteners 90 may also be used to secure mounting plate 84 to bulkhead 80d.

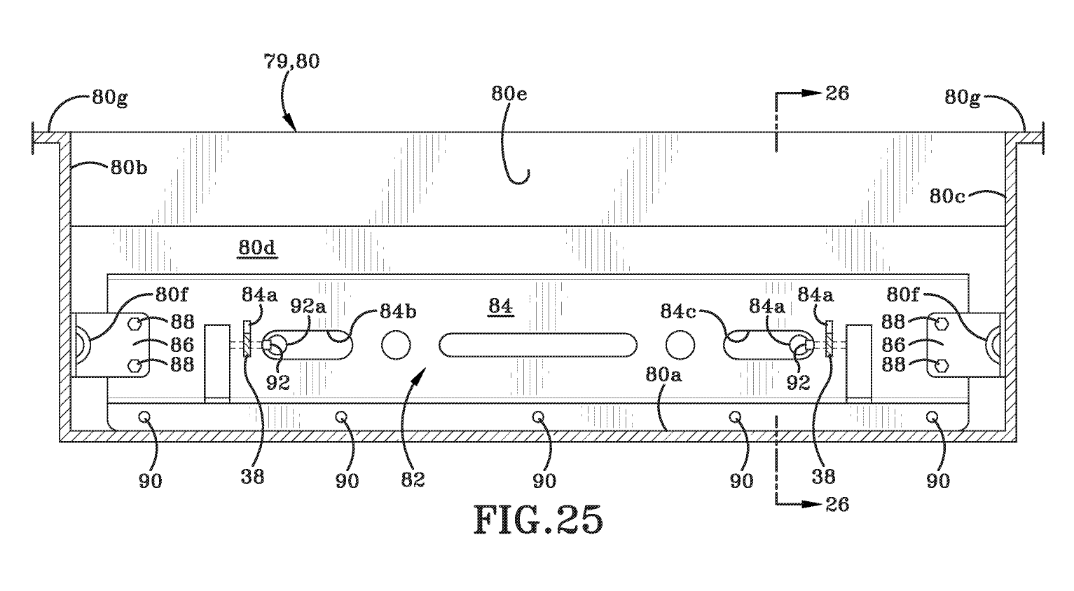

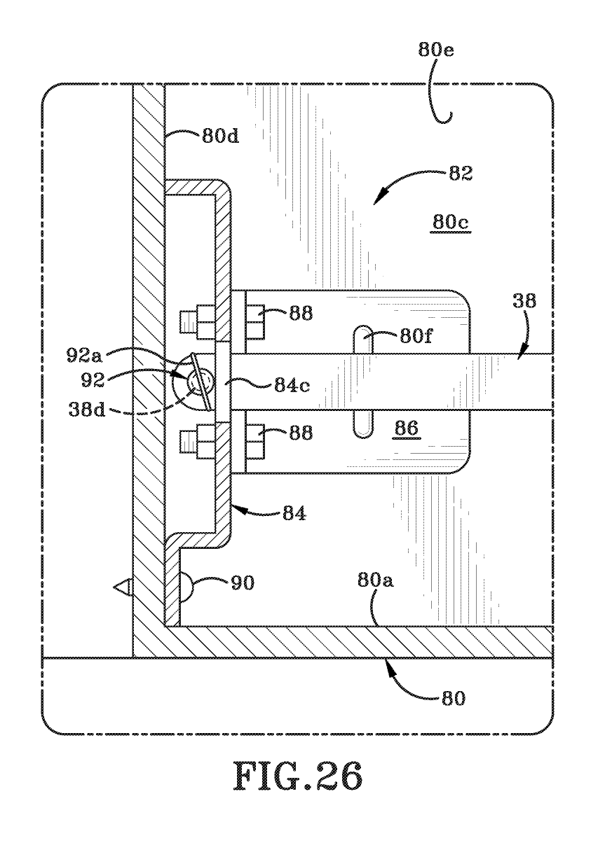

As best seen in FIG. 25, mounting plate 84 may include a plurality of apertures and openings, including a pair of spaced-apart slots 84a that extend between an exterior an interior surface of mounting plate 84. Slots 84a are spaced at a distance away from each other that is equivalent to the lateral spacing between guide bars 38 on unit 10. When unit 10 is engaged with truck mounting assembly 82, guide bars 38 extending outwardly from base 12 are moved into alignment with slots 84a in mounting plate 84. Unit 10 is moved in the direction of arrow “P” (FIG. 22) until legs 20 are proximate the outer end of tailgate 81 of truck 79. At this point, legs 20 are disengaged from base 12. Pins 40 are disengaged from each of the left side 12c and right side 12d of base 12 so that the associated guide bar 38 is free to slide within the associated pocket 12q in base 12. Guide bars 38 are each pulled outwardly for a distance from unit 10 so that they extend further rearwardly from rear end 12b. The end of each guide bar 38 that includes aperture 38d is inserted through one of the slots 84a defined in mounting plate 84. An end of a spring-loaded locking pin 92 (FIGS. 25 and 26) may then be inserted through aperture 38d, thus securing guide bar 38 to mounting plate 84. A ring 92a (FIG. 25) attached to locking pin 92 may be accessed through one of the openings 84b, 84c defined in mounting plate 84. Ring 92a may be manipulated by inserting a fingertip therethrough.

A roll pin is provided on the end of guide bar 38 that is located proximate front end 12a. The roll pin helps to prevent unit 10 from being pulled off tailgate 81 when pins 40 are absent from apertures 12s in left and right sides 12c, 12d. Once guide bars 38 are secured to truck mounting assembly 82, unit 10 may be moved in the direction of arrow “P” (FIG. 23) or the opposite direction thereof in order to position unit 10 partially on floor 80a of truck bed 80 and partially on upper surface 81a of tailgate 81. When the desired location for unit 10 is found, each pin 40 is inserted through the aperture 12s in one of the left side 12c and right side 12d of base 12 and into an aligned one of the apertures 38a-38e in guide bar 38 to lock guide bar 38 in place. This is a safety feature that helps ensure that unit 10 cannot be accidentally pulled off tailgate 81 as a user raises and lowers roof 14 or contacts unit 10 in any other adverse way.

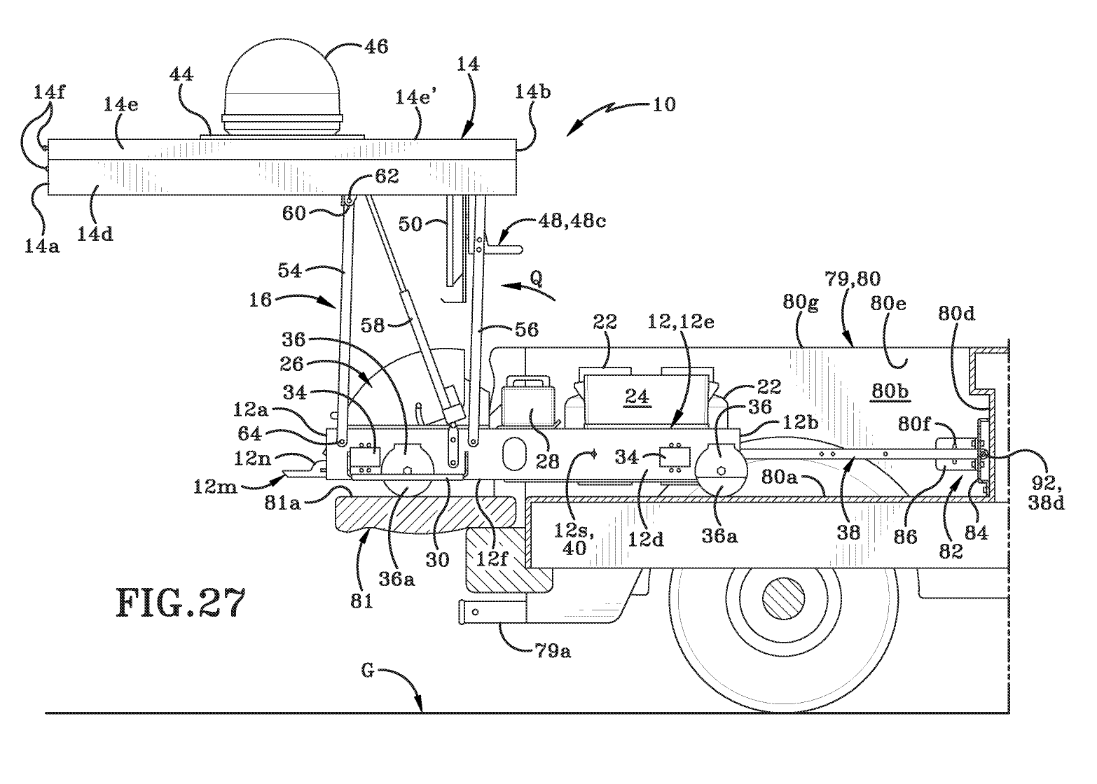

Roof 14 may then be moved into a position where it will extend over a region of ground “G” that is located rearwardly of tailgate 81 and forwardly in front of front end 12a of base 12. In order to move roof 14 to this position, linkage assembly 16 is activated (i.e., actuator 58 is activated) to pivot in the direction of arrow “Q” (FIG. 27). The user may then open door 12m to gain access to controls 26a of barbeque grill 26 and may begin grilling foodstuffs on barbeque 26. The user may access all of the accessories in unit, such as fuel tanks 22, coolers 24, power pack 26 and any tools, or implements stored in compartment 12k, simply by leaning over the side wall 80b or 80c of truck bed 80. Accessories such as shelves 30 may also be engaged with unit 10 while base 12 is resting on tailgate 81. The satellite receiver 46 and television 50 and any audio system or other accessory provided on unit 10 may also be used.

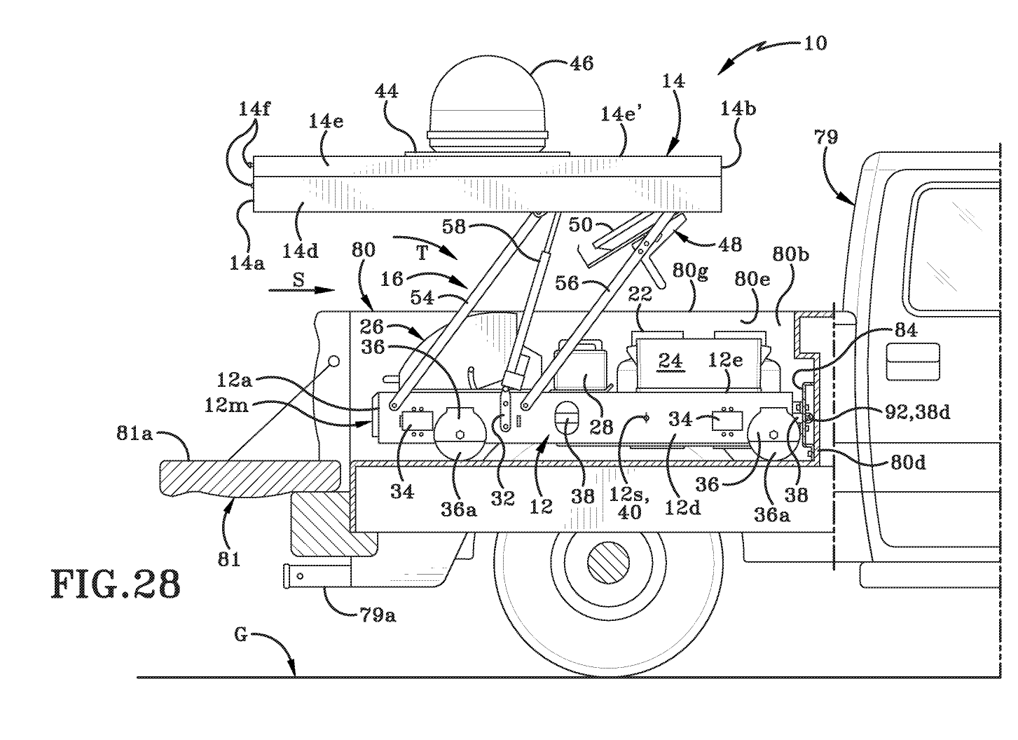

When the user wishes to transport unit 10 from one location to another, shelves 30, if engaged, may be removed from unit 10, pins 40 are withdrawn from left and right sides 12c, 12d and unit 10 is pushed inwardly into the cavity 80e of truck bed 80 until the front end 12a of base 12 is located a distance inwardly within cavity 80e and away from tailgate 81 and physically engages with bulkhead 80. As unit 10 is pushed inwardly into truck bed 80, guide bars 38 slide back into pockets 12q. When unit 10 is entirely located within truck bed 80 and clear of tailgate 81, pins 40 are re-engaged with left and right sides 12c, 12d and are inserted into aligned apertures 38a-38e defined in guide bars 38. Roof 14 is then lowered and moved rearwardly by linkage assembly 16 in the directions indicated by arrows “S” and “T” in FIG. 28. Because of the larger size of roof 14, instead of roof 14 moving downwardly into the collapsed position shown in FIG. 10, roof 14 only moves downwardly until it comes to rest on the upper rim 80g of truck bed 80. (It should be noted that the width “W1” of roof 14 is substantially the same as the distance between sides 80b and 80c of truck bed 80. The upper rim 80g (i.e., uppermost ends of sides 80b and 80c and of bulkhead 80d) supports roof 14 a distance away from base 12. Tailgate 81 may then be shut. Unit 10 is retained entirely within the cavity 80e and is covered by roof 14. As illustrated in FIG. 29, preferably the length “L1” of roof 14 is such that it is substantially equal to the distance between an outer end of the closed tailgate 81 and the portion of rim 80g provided by bulkhead 80d. Roof 14 thus effectively closes off any access to the interior of truck bed 80. Roof 14 thereby protects the base 12 and any accessories on base 12 or in truck bed 80 from the elements and from being stolen or tampered with. FIG. 29 also shows that a hitch tray 94 may be engaged with a hitch assembly 79a provided on truck 79. A cooler 24a may be secured and transported on hitch tray 94 engaged with hitch 79a.

When the user wishes to disengage unit 10 from truck 79, the steps described above with respect to the installation of unit 10 in truck bed 80 are simply reversed. The mounting plate 84 may remain permanently installed on truck 79. The short length box (which is approximately 66 inches long) is the preferred box length. However, box length extensions may be utilized to properly fit mid-length and full-length box styles.

Unit 10 disclosed above is therefore useable in a number of different ways. As described, in a first instance unit 10 may be used as a stand-alone or free-standing grilling unit. Secondly, unit 10 may be folded up and wheeled away for vertical storage. The folding reduces the overall footprint of the unit on the ground and thus the unit takes up less storage space on a patio or in a garage. Thirdly, unit 10 may be installed and secured within a truck bed 80 and is movable between a use position and a transportation position. A variety of different accessories are engageable with unit 10 to facilitate grilling and tailgating and also to make the unit easy to manipulate and use.

Various pins have been disclosed herein for securing components on unit 10 in place. Some or all of these pins may be ball lock pins. It will be understood, however, that any other type of pin, fastener or securement device may be utilized for the purpose of securing components on unit 10 in place.

Although not illustrated in the attached figures, it will be understood that the various components that may be removed from unit 10 at various times, such as legs 18, 20, roll plates 74, pins, etc. may be engaged in dedicated locations provided on unit 10. These dedicated storage locations ensure that all components of unit 10 and the various accessories are kept in a single location ready and available for use at any time.

Although not illustrated in the attached figures, it will be understood that an audio system may also be provided on roof 14 or base 12 and that power pack 28 may be operatively engaged therewith to provide power to operate the audio system.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A mobile grilling unit comprising:
a base;
a barbeque grill engaged with the base;
a roof oriented substantially parallel to the base; and
at least one linkage assembly engaging the roof to the base; said at least one linkage assembly being actuatable to move the roof between a raised position and a lowered position relative to the base.

2. The mobile grilling unit according to claim 1, wherein the at least one linkage assembly is a threaded rod and cylinder or a pneumatic cylinder.

3. The mobile grilling unit according to claim 1, further comprising at least one first leg and at least one second leg that are selectively detachably engageable with the base, said at least one first leg being spaced longitudinally from said at least one second leg.

4. The mobile grilling unit according to claim 1, further comprising at least one first wheel and at least one second wheel engaged with the base; wherein said at least one first wheel is spaced longitudinally from said at least one second wheel.

5. The mobile grilling unit according to claim 1, wherein the base has a front end, a back end and a top wall extending between the front end and back end; wherein when the roof is in the lowered position, the top wall of the base is covered by the roof; and wherein when the roof is in the raised position, a region of the top wall of the base is not covered by the roof and a section of the roof is located forwardly of the front end of the base.

6. The mobile grilling unit according to claim 1, wherein the base includes a front end, a back end, and a top wall extending between the front end and the back end; and wherein at least one aperture is defined in the top wall; and each of the at least one aperture is adapted to receive an accessory device therein.

7. The mobile grilling unit according to claim 6, wherein a first one of the at least one aperture receives the barbeque grill therein.

8. The mobile grilling unit according to claim 7, wherein a second one of the at least one aperture receives one of a fuel tank, a cooler, or a power pack therein.

9. The mobile grilling unit according to claim 1, wherein the base defines a storage compartment therein.

10. The mobile grilling unit according to claim 1, further comprising a connector assembly engaged with the base; wherein the connector assembly is adapted to selectively secure the base to a wall of a truck bed.

11. The mobile grilling unit according to claim 10, wherein the connector assembly comprises one or more guide bars operatively engaged with the base and a mounting plate adapted to be engaged with the wall of the truck bed; and wherein the one or more guide bars are selectively engageable with the mounting plate.

12. The mobile grilling unit according to claim 11, wherein the base defines one or more pockets therein and each of the one or more guide bars is slidably received in one of the one or more pockets.

13. The mobile grilling unit according to claim 1, further comprising a wheel assembly selectively engageable with a front end of the roof and a front end of the base when the roof is in the lowered position; wherein the mobile grilling unit is selectively movable through about ninety degrees from a near-horizontal use position to a near-vertical storage position; and when in the storage position, the roof and base are supported on the wheel assembly.

14. The mobile grilling unit according to claim 1, further comprising a power pack selectively engageable with the linkage assembly.

15. A method of utilizing a mobile grilling unit comprising steps of:
providing a mobile grilling unit including a base, a barbeque grill engaged with the base; a roof oriented substantially parallel to the base; and a linkage assembly engaged the roof to the base;
actuating the linkage assembly; and
moving the roof between a raised position and a lowered position relative to the base.

16. The method according to claim 15, wherein the step of actuating the linkage assembly results in the roof being moved to the raised position; and wherein the method further comprises a step of:
grilling food on the barbeque grill.

17. The method according to claim 15, wherein the step of actuating the linkage assembly results in the roof being moved to the raised position, and the method further comprises steps of:
extending a region of the roof beyond a front end of the base; and
sheltering a person grilling food on the barbeque grill.

18. The method according to claim 15, further comprising steps of:
moving the mobile grilling unit between a use position and a storage position; and
reducing a footprint of the mobile grilling unit on a ground surface when the mobile grilling unit is moved from the use position to the storage position.

19. The method according to claim 18, further comprising:
rotating the mobile grilling unit through about ninety degrees between the near-horizontal use position and the near-vertical storage position.

20. The method according to claim 18, wherein the step of moving the mobile grilling unit between the near-horizontal use position and the near-vertical storage position includes steps of:
engaging roll plates on front legs on the base;
engaging a wheel assembly with a front end of the base and a front end of the roof;
contacting a ground surface with an arcuate surface of each roll plate;
rotating the mobile grilling unit onto the wheel assembly; and
supporting the mobile grilling unit on the wheel assembly.

21. The method according to claim 15, further comprising a step of:
moving the mobile grilling unit between a free-standing position and a tailgating position.

22. The method according to claim 21, wherein the step of moving the mobile grilling unit into a tailgating position comprises steps of:
positioning the mobile grilling unit on a bed of a truck;
securing the mobile grilling unit to the truck bed; and
moving the mobile grilling unit into a first region of the truck bed for transportation and into a second region of the truck bed for barbequing.

23. The method according to claim 22, wherein the step of securing further comprises steps of:
engaging a mounting plate to a wall on the truck bed;
sliding a pair of guide bars out of the base;
engaging ends of the pair of guide bars with the mounting plate; and
locking the pair of guide bars in place.

24. The method according to claim 22, wherein the step of moving the mobile grilling unit includes moving the mobile grilling unit into a transportation position including steps of:
moving the base to a position where the base clears a tailgate on the truck;
closing the tailgate;
actuating the linkage assembly to lower the roof toward the base; and
contacting an upper end of the tailgate and walls defining the truck bed with the roof.

25. A mobile grilling unit comprising:
a base adapted to retain a barbeque grill therein;
a roof;
a linkage assembly connecting the base and roof together and being operable to adjust a position of the roof relative to the base; and
a pair of first legs and a pair of second legs selectively detachably engageable with the base;
wherein the mobile grilling unit is selectively adjustable between a first position, a second position, and a third position; and when in the first position, the mobile grilling unit is engaged with a truck bed; when in the second position the mobile grilling unit is free-standing and located remote from the truck bed; and when in the third position the mobile grilling unit is rotated through ninety degrees and has a reduced footprint on a ground surface upon which the mobile grilling unit stands and is storable remote from the truck bed.
